(19) United States
(12) Patent Application Publication
(10) Pub. No.: US 2025/0119870 A1
(43) Pub. Date: Apr. 10, 2025

(54) PRE-PAGING ALERT MONITORING PROCEDURE

(71) Applicant: QUALCOMM Incorporated, San Diego, CA (US)

(72) Inventors: Bharat SHRESTHA, San Diego, CA (US); Chiranjib SAHA, Lakeside, CA (US); Umesh PHUYAL, San Diego, CA (US); Xiao Feng WANG, San Diego, CA (US); Peter GAAL, San Diego, CA (US); Alberto RICO ALVARINO, San Diego, CA (US); Masato KITAZOE, Hachiouji-shi (JP)

(21) Appl. No.: 18/481,546

(22) Filed: Oct. 5, 2023

(51) Int. Cl. H04W 68/02; H04W 48/02

(52) U.S. Cl. CPC H04W 68/02; H04W 48/02

(57) ABSTRACT

Methods, systems, and devices for wireless communication are described. A user equipment may receive an indication of a pre-paging signal configuration for reception of a pre-paging signal associated with a first cell. The UE may monitor for the pre-paging signal from the first cell in response to one or more conditions being satisfied, the one or more conditions based at least in part on the pre-paging signal configuration. In some examples, the UE may receive, based on the monitoring, the pre-paging signal from the first cell, and the UE may output an alert message associated with receiving the pre-paging signal, the alert message indicating for the UE to be relocated to improve coverage.

### FIELD OF TECHNOLOGY

The following relates to wireless communication, including pre-paging alert monitoring procedure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some examples, a UE may communicate with a network entity via one or more cells.

### SUMMARY

The described techniques relate to improved methods, systems, devices, and apparatuses that support pre-paging alert monitoring procedure. For example, the described techniques provide for a UE to be configured with a pre-paging configuration that may define a decision process for the UE to determine when to monitor for pre-paging signals. For example, the UE may be configured with a first signal quality threshold, and regular paging may be performed if the first threshold is satisfied. In some examples, the UE may be configured, via the pre-paging configuration, with a second signal quality threshold that is lower than the first threshold, such that the UE may perform monitoring for the pre-paging signal if the second threshold is satisfied but the first threshold is not satisfied. In some cases, the UE may be configured to monitor for a pre-paging signal from a cell based on the UE having previously stored valid system information block (SIB) data associated with the cell. In some examples, if the UE performs a cell barring procedure to bar a cell, but the UE does not detect another cell in a cell discovery procedure, the UE may be configured to monitor for a pre-paging signal from the barred cell. Accordingly, the UE may operate in accordance with the pre-paging configuration, which may improve the ability of the UE to determine when to monitor for a pre-paging signal.

A method for wireless communications by a UE is described. The method may include receiving an indication of a pre-paging signal configuration for reception of a pre-paging signal associated with a first cell, monitoring for the pre-paging signal from the first cell in response to one or more conditions being satisfied, where the one or more conditions for monitoring the pre-paging signal are associated with the pre-paging signal configuration, and where the one or more conditions for monitoring the pre-paging signal include failure of a criterion associated with selection of the first cell via a cell selection procedure, receiving, based on the monitoring, the pre-paging signal from the first cell, and outputting an alert message associated with receiving the pre-paging signal.

A UE for wireless communications is described. The UE may include one or more memories storing processor executable code, and one or more processors coupled with the one or more memories. The one or more processors may individually or collectively be operable to execute the code to cause the UE to receive an indication of a pre-paging signal configuration for reception of a pre-paging signal associated with a first cell, monitor for the pre-paging signal from the first cell in response to one or more conditions being satisfied, where the one or more conditions for monitoring the pre-paging signal are associated with the pre-paging signal configuration, and where the one or more conditions for monitoring the pre-paging signal include failure of a criterion associated with selection of the first cell via a cell selection procedure, receive, based on the monitoring, the pre-paging signal from the first cell, and output an alert message associated with receiving the pre-paging signal.

Another UE for wireless communications is described. The UE may include means for receiving an indication of a pre-paging signal configuration for reception of a pre-paging signal associated with a first cell, means for monitoring for the pre-paging signal from the first cell in response to one or more conditions being satisfied, where the one or more conditions for monitoring the pre-paging signal are associated with the pre-paging signal configuration, and where the one or more conditions for monitoring the pre-paging signal include failure of a criterion associated with selection of the first cell via a cell selection procedure, means for receiving, based on the monitoring, the pre-paging signal from the first cell, and means for outputting an alert message associated with receiving the pre-paging signal.

A non-transitory computer-readable medium storing code for wireless communications is described. The code may include instructions executable by a processor to receive an indication of a pre-paging signal configuration for reception of a pre-paging signal associated with a first cell, monitor for the pre-paging signal from the first cell in response to one or more conditions being satisfied, where the one or more conditions for monitoring the pre-paging signal are associated with the pre-paging signal configuration, and where the one or more conditions for monitoring the pre-paging signal include failure of a criterion associated with selection of the first cell via a cell selection procedure, receive, based on the monitoring, the pre-paging signal from the first cell, and output an alert message associated with receiving the pre-paging signal.

Some examples of the method, UEs, and non-transitory computer-readable medium described herein may further include operations, features, means, or instructions for measuring a reference signal to obtain a reference signal received power, where the failure of the criterion associated with selection of the first cell includes the reference signal received power failing to satisfy a first threshold value associated with monitoring for a paging message from the first cell.

In some examples of the method, UEs, and non-transitory computer-readable medium described herein, the one or more conditions being satisfied further includes the reference signal received power satisfying a second threshold value that may be lower than the first threshold value.

Some examples of the method, UEs, and non-transitory computer-readable medium described herein may further include operations, features, means, or instructions for storing data associated with one or more SIBs for the first cell, where monitoring for the pre-paging signal may be further based on storing the data associated with the one or more SIBs. In some examples of the method, UEs, and non-transitory computer-readable medium described herein, the one or more conditions being satisfied further includes the UE being within a SIB tracking area associated with the one or more SIBs.

Some examples of the method, UEs, and non-transitory computer-readable medium described herein may further include operations, features, means, or instructions for monitoring, in response to at least one condition of the one or more conditions being satisfied, for one or more SIBs associated with the first cell and performing a cell barring procedure to bar the first cell based on failing to detect the one or more SIBs.

Some examples of the method, UEs, and non-transitory computer-readable medium described herein may further include operations, features, means, or instructions for performing, after performing the cell barring procedure to bar the first cell, a cell detection procedure for a second cell, where monitoring for the pre-paging signal from the first cell may be based on failing to detect the second cell via the cell detection procedure.

In some examples of the method, UEs, and non-transitory computer-readable medium described herein, the one or more conditions being satisfied further includes the UE being with a geographical area indicated by the pre-paging signal configuration.

Some examples of the method, UEs, and non-transitory computer-readable medium described herein may further include operations, features, means, or instructions for transmitting a capability message indicating a capability of the UE to operate in accordance with one or more pre-paging modes, where receiving the indication of the pre-paging signal configuration is associated with the indicated capability of the UE.

In some examples of the method, UEs, and non-transitory computer-readable medium described herein, the pre-paging signal configuration indicates at least one pre-paging mode in accordance with the capability of the UE, the pre-paging mode may be associated with a set of one or more physical cell identifiers, a set of one or more frequency bandwidths, a set of one or more geographical areas, or any combination thereof associated with monitoring for the pre-paging signal, and monitoring for the pre-paging signal may be based on the pre-paging mode.

In some examples of the method, UEs, and non-transitory computer-readable medium described herein, the one or more conditions being satisfied further includes the UE operating without having received a synchronization signal block signal associated with the first cell, the UE operating having received the synchronization signal block signal, or the UE operating having received the synchronization signal block signal and paging downlink control information associated with the first cell.

In some examples of the method, UEs, and non-transitory computer-readable medium described herein, the one or more conditions being satisfied further includes the UE operating without having obtained one or more valid SIBs associated with the first cell or the UE operating having obtained one or more valid SIBs associated with the first cell.

In some examples of the method, UEs, and non-transitory computer-readable medium described herein, the pre-paging signal configuration indicates a time offset between a pre-paging occasion for receiving the pre-paging signal and a corresponding paging occasion for receiving the paging message, from the first cell, corresponding to the pre-paging signal.

In some examples of the method, UEs, and non-transitory computer-readable medium described herein, receiving the indication of the pre-paging signal configuration may include operations, features, means, or instructions for receiving a radio resource control message that indicates the pre-paging signal configuration.

Some examples of the method, UEs, and non-transitory computer-readable medium described herein may further include operations, features, means, or instructions for initiating a random access procedure for communications with the first cell based on receiving the pre-paging signal.

In some examples of the method, UEs, and non-transitory computer-readable medium described herein, the pre-paging signal indicates a flag type of a set of multiple flag types and the alert message may be output based on the flag type.

In some examples of the method, UEs, and non-transitory computer-readable medium described herein, the set of multiple flag types includes at least one of a voice call flag type, a spam call flag type, a registration update flag type, delay tolerant uplink data flag type, important uplink data flag type, a connected mode flag type, or a flag type associated with the UE being in a cell selection state for a duration exceeding a threshold duration.

In some examples of the method, UEs, and non-transitory computer-readable medium described herein, each flag type of the set of multiple flag types corresponds to at least one alert type of a set of multiple alert types, the set of multiple alert types including a silent alert message, a vibration alert message, a ring alert message, and an omitted alert message and the alert message corresponds to the indicated flag type.

Some examples of the method, UEs, and non-transitory computer-readable medium described herein may further include operations, features, means, or instructions for initiating a radio resource control reestablishment procedure based on triggering a radio link failure procedure while operating in a connected mode, where outputting the alert message may be based on initiating the radio resource control reestablishment procedure.

In some examples of the method, UEs, and non-transitory computer-readable medium described herein, the alert message may be output based on a quantity of radio resource control reestablishment procedure attempts exceeding a threshold quantity of attempts.

In some examples of the method, UEs, and non-transitory computer-readable medium described herein, the alert message may be output based on the radio resource control reestablishment procedure being unsuccessful.

In some examples of the method, UEs, and non-transitory computer-readable medium described herein, the alert message indicates for the UE to be relocated to a different physical location.

A method for wireless communications by a network entity is described. The method may include transmitting, to a UE, an indication of a pre-paging signal configuration associated with monitoring by the UE for a pre-paging signal associated with a first cell, where the monitoring for the pre-paging signal is dependent on satisfaction of one on more conditions that are associated with the pre-paging signal configuration, and where the one or more conditions being satisfied comprises failure of a criterion associated with selection of the first cell via a cell selection procedure, and transmitting, to the UE and via the first cell, the pre-paging signal in accordance with the pre-paging signal configuration, where the pre-paging signal indicates that the UE is to output an alert message.

A network entity for wireless communications is described. The network entity may include one or more memories storing processor executable code, and one or more processors coupled with the one or more memories. The one or more processors may be individually or collectively operable to execute the code to cause the network entity to transmit, to a UE, an indication of a pre-paging signal configuration associated with monitoring by the UE for a pre-paging signal associated with a first cell, where the monitoring for the pre-paging signal is dependent on satisfaction of one on more conditions that are associated with the pre-paging signal configuration, and where the one or more conditions being satisfied comprises failure of a criterion associated with selection of the first cell via a cell selection procedure, and transmit, to the UE and via the first cell, the pre-paging signal in accordance with the pre-paging signal configuration, where the pre-paging signal indicates that the UE is to output an alert message.

Another network entity for wireless communications is described. The network entity may include means for transmitting, to a UE, an indication of a pre-paging signal configuration associated with monitoring by the UE for a pre-paging signal associated with a first cell, where the monitoring for the pre-paging signal is dependent on satisfaction of one on more conditions that are associated with the pre-paging signal configuration, and where the one or more conditions being satisfied comprises failure of a criterion associated with selection of the first cell via a cell selection procedure, and means for transmitting, to the UE and via the first cell, the pre-paging signal in accordance with the pre-paging signal configuration, where the pre-paging signal indicates that the UE is to output an alert message.

A non-transitory computer-readable medium storing code for wireless communications is described. The code may include instructions executable by a processor to transmit, to a UE, an indication of a pre-paging signal configuration associated with monitoring by the UE for a pre-paging signal associated with a first cell, where the monitoring for the pre-paging signal is dependent on satisfaction of one on more conditions that are associated with the pre-paging signal configuration, and where the one or more conditions being satisfied comprises failure of a criterion associated with selection of the first cell via a cell selection procedure, and transmit, to the UE and via the first cell, the pre-paging signal in accordance with the pre-paging signal configuration, where the pre-paging signal indicates that the UE is to output an alert message.

Some examples of the method, network entities, and non-transitory computer-readable medium described herein may further include operations, features, means, or instructions for obtaining, from a network function, an indication of the pre-paging signal configuration.

In some examples of the method, network entities, and non-transitory computer-readable medium described herein, the failure of the criterion associated with selection of the first cell includes a reference signal received power failing to satisfy a first threshold value associated with monitoring for a paging message from the network entity.

In some examples of the method, network entities, and non-transitory computer-readable medium described herein, the one or more conditions being satisfied further includes the reference signal received power satisfying a second threshold value that is lower than the first threshold.

In some examples of the method, network entities, and non-transitory computer-readable medium described herein, the one or more conditions being satisfied further includes the UE being within a SIB tracking area associated with the first cell.

In some examples of the method, network entities, and non-transitory computer-readable medium described herein, the one or more conditions being satisfied further includes the UE being within a geographical area indicated by the pre-paging signal configuration.

Some examples of the method, network entities, and non-transitory computer-readable medium described herein may further include operations, features, means, or instructions for receiving a capability message indicating a capability of the UE to operate in accordance with one or more pre-paging modes.

In some examples of the method, network entities, and non-transitory computer-readable medium described herein, the pre-paging signal configuration indicates a time offset between a pre-paging occasion for receiving the pre-paging signal and a corresponding paging occasion for receiving the paging message.

In some examples of the method, network entities, and non-transitory computer-readable medium described herein, transmitting the indication of the pre-paging signal configuration may include operations, features, means, or instructions for transmitting a radio resource control message that indicates the pre-paging signal configuration.

In some examples of the method, network entities, and non-transitory computer-readable medium described herein, the pre-paging signal indicates a flag type of a set of multiple flag types and the alert message may be output based on the flag type.

In some examples of the method, network entities, and non-transitory computer-readable medium described herein, the set of multiple flag types includes at least one of a voice call flag type, a spam call flag type, a registration update flag type, delay tolerant uplink data flag type, important uplink data flag type, a connected mode flag type, or a flag type associated with the UE being in a cell selection state for a duration exceeding a threshold duration.

In some examples of the method, network entities, and non-transitory computer-readable medium described herein, each flag type of the set of multiple flag types corresponds to at least one alert type of a set of multiple alert types, the set of multiple alert types including a silent alert message, a vibration alert message, a ring alert message, and an omitted alert message and the alert message corresponds to the indicated flag type.

### BRIEF DESCRIPTION OF THE DRAWINGS

FIG. 1 shows an example of a wireless communications system that supports pre-paging alert monitoring procedure in accordance with one or more aspects of the present disclosure.

FIG. 2 shows an example of a wireless communications system that supports pre-paging alert monitoring procedure in accordance with one or more aspects of the present disclosure.

FIG. 3 shows an example of a flowchart that supports pre-paging alert monitoring procedure in accordance with one or more aspects of the present disclosure.

FIG. 4 shows an example of a process flow that supports pre-paging alert monitoring procedure in accordance with one or more aspects of the present disclosure.

FIGS. 5A and 5B show an example of flowcharts that support pre-paging alert monitoring procedure in accordance with one or more aspects of the present disclosure.

FIG. 6 shows an example of a process flow that supports pre-paging alert monitoring procedure in accordance with one or more aspects of the present disclosure.

FIGS. 7 and 8 show block diagrams of devices that support pre-paging alert monitoring procedure in accordance with one or more aspects of the present disclosure.

FIG. 9 shows a block diagram of a communications manager that supports pre-paging alert monitoring procedure in accordance with one or more aspects of the present disclosure.

FIG. 10 shows a diagram of a system including a device that supports pre-paging alert monitoring procedure in accordance with one or more aspects of the present disclosure.

FIGS. 11 and 12 show block diagrams of devices that support pre-paging alert monitoring procedure in accordance with one or more aspects of the present disclosure.

FIG. 13 shows a block diagram of a communications manager that supports pre-paging alert monitoring procedure in accordance with one or more aspects of the present disclosure.

FIG. 14 shows a diagram of a system including a device that supports pre-paging alert monitoring procedure in accordance with one or more aspects of the present disclosure.

FIGS. 15 through 18 show flowcharts illustrating methods that support pre-paging alert monitoring procedure in accordance with one or more aspects of the present disclosure.

### DETAILED DESCRIPTION

In some wireless communications systems, a UE in communication with a cell may experience poor coverage scenarios. Such scenarios may arise for UEs within non-terrestrial networks (e.g., with cells hosted by satellites), but such scenarios are not limited to such networks. For example, in any type of wireless communications system, a UE may experience poor channel conditions (e.g., blockage) due to a positioning of the UE, which may decrease the ability of the UE to receive paging messages, or to communicate uplink messages in response to paging messages. In some examples, the UE may receive a pre-paging alert, which may be a more robust signal type relative to a paging message such that the UE may receive the pre-paging signal even when coverage is poor. The UE may output an alert message in response to receiving the pre-paging signal to indicate that the UE is experiencing poor coverage, and that moving to a different location may be beneficial for improving coverage. However, the UE may not be configured with a procedure for when to initiate monitoring for the pre-paging signal, which may result in a delayed or omitted alert message. As such, defining scenarios during which the UE is to monitor for pre-paging signals may be beneficial.

In accordance with examples as described herein, a UE may be configured with a pre-paging configuration that may define a decision process for the UE to determine when to monitor for pre-paging signals. The UE may be configured with a first signal quality threshold, and regular paging may be performed if the first threshold is satisfied. In some examples, the UE may be configured, via the pre-paging configuration, with a second signal quality threshold that is lower than the first threshold, such that the UE may perform monitoring for the pre-paging signal if the second threshold is satisfied but the first threshold is not satisfied. In some cases, the UE may be configured to monitor for a pre-paging signal from a cell based on the UE having previously stored valid SIB data associated with the cell. In some examples, if the UE performs a cell barring procedure to bar a cell, but the UE does not detect another cell in a cell discovery procedure, the UE may be configured to monitor for a pre-paging signal from the barred cell. Accordingly, the UE may operate in accordance with the pre-paging configuration, which may improve the ability of the UE to determine when to monitor for a pre-paging signal.

Aspects of the disclosure are initially described in the context of wireless communications systems. Aspects of the disclosure are additionally described in the context of flowcharts and process flows. Aspects of the disclosure are further illustrated by and described with reference to apparatus diagrams, system diagrams, and flowcharts that relate to pre-paging alert monitoring procedure.

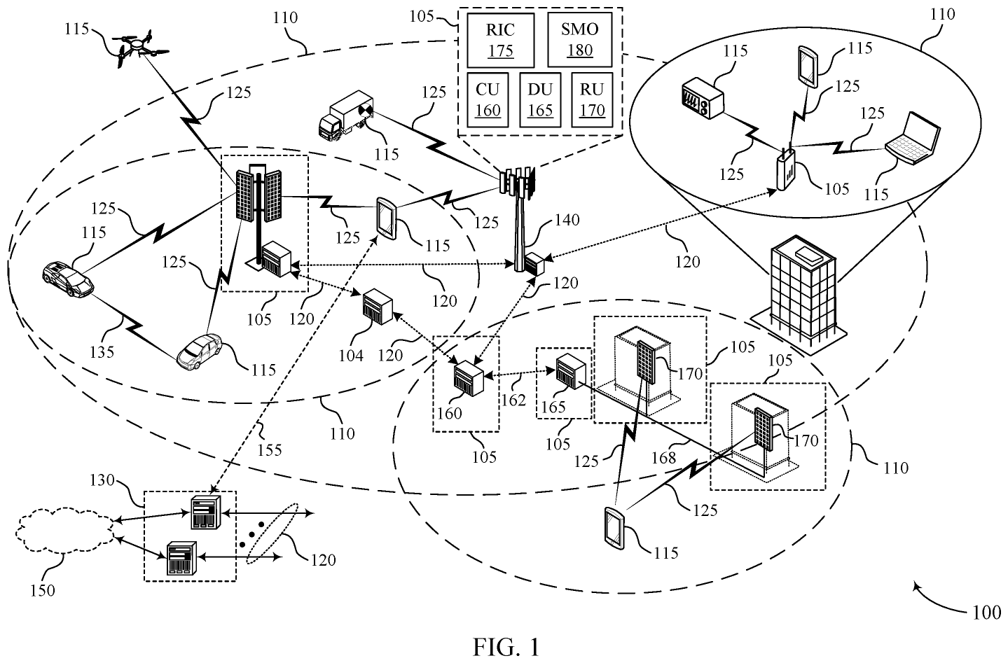

FIG. 1 shows an example of a wireless communications system 100 that supports pre-paging alert monitoring procedure in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support pre-paging alert monitoring procedure as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity (e.g., a network entity 105) used for communication with the network entity 105 (e.g., using a carrier) and may be associated with an identifier for distinguishing neighboring cells (e.g., a physical cell identifier (PCI), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices. In some examples, a cell may be an example of a non-terrestrial cell, such as a satellite.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a UE 115 in communication with a cell may experience poor coverage scenarios. In some examples, the UE 115 may receive a pre-paging alert from a cell, which may be a more robust signal type relative to a paging message such that the UE 115 may receive the pre-paging signal even when uplink transmissions suffer. For example, the UE 115 may be able to decode SIBs, synchronization signal blocks (SSBs), or paging messages received from the cell, but uplink transmissions (e.g., Msg1 transmissions, Msg3 transmissions) by the UE 115 may fail. Additionally, or alternatively, a paging message may be decoded by the UE 115, but the UE 115 may not be able to successfully determine a position of the UE 115 due to poor global navigation satellite system (GNSS) signal, so the UE 115 may not be able to communicate an uplink message. As such, the pre-paging signal may assist the UE 115 (e.g., and a user of the UE 115) in obtaining better coverage, for example, by assisting the UE 115 decide when the UE 115 should relocate to an area with better coverage. However, the UE may not be configured with a procedure for when to initiate monitoring for the pre-paging signal. For example, the UE 115 may not be configured with an alert mechanism for operating in an idle mode (e.g., an RRC idle mode), an inactive mode (e.g., an RRC inactive mode), or a connected mode (e.g., an RRC connected mode). As such, defining scenarios during which the UE is to monitor for pre-paging signals may be beneficial.

In accordance with examples as described herein, the UE 115 may be configured with a pre-paging configuration that may define a decision process for the UE 115 to determine when to monitor for pre-paging signals. The UE 115 may be configured with a first signal quality threshold (e.g., a reference signal received power (RSRP) threshold, a reference signal received quality (RSRQ) threshold), and regular paging may be performed if the first threshold is satisfied. In some examples, the UE 115 may be configured, via the pre-paging configuration, with a second signal quality threshold that is lower than the first threshold, such that the UE 115 may perform monitoring for the pre-paging signal if the second threshold is satisfied but the first threshold is not satisfied. In some cases, the UE 115 may be configured to monitor for a pre-paging signal from a cell based on the UE 115 having previously stored valid SIB data associated with the cell. In some examples, the UE 115 may be configured to monitor for the pre-paging signal when in an idle or inactive mode (e.g., an RRC idle or an RRC inactive mode), for example, after receiving a release message (e.g., an RRC release message). Accordingly, the UE 115 may operate in accordance with the pre-paging configuration, which may improve the ability of the UE 115 to determine when to monitor for a pre-paging signal.

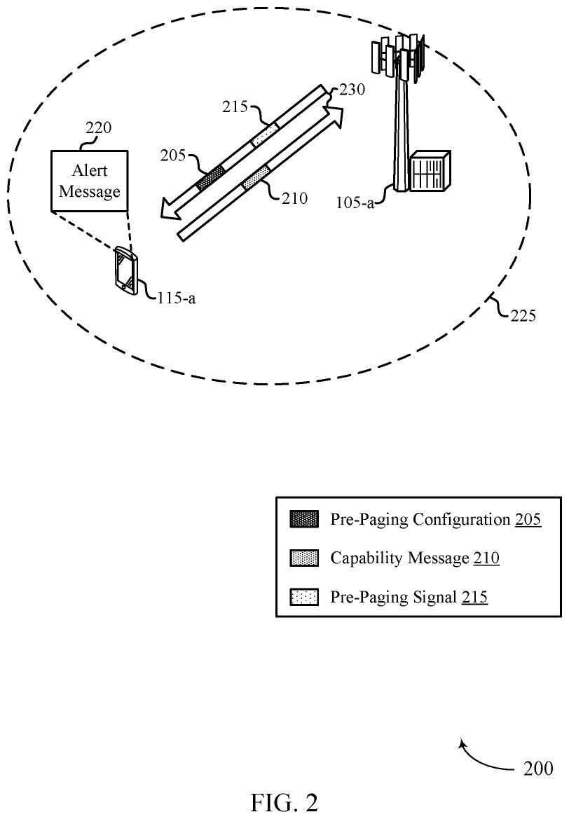

FIG. 2 shows an example of a wireless communications system 200 that supports pre-paging alert monitoring procedure in accordance with one or more aspects of the present disclosure. The wireless communications system 200 illustrates communications related to a pre-paging signal 215 communicated between a UE 115-a and a network entity 105-a, which may be examples of corresponding devices as described herein, with reference to FIG. 1. For example, the network entity 105-a may include or be an example of a cell, as described with reference to FIG. 1. In some cases, the wireless communications system 200 may be an example of a non-terrestrial network. For example, the network entity 105-a may be an example of a satellite, which may provide coverage for the UE 115-a. In some examples, the UE 115-a and the network entity 105-a may communicate via communication links 230, which may be examples of communication links 165 as described with reference to FIG. 1.

In some cases, the UE 115-a may experience poor coverage when in communications with the network entity 105-a. For example, the UE 115-a may experience blockage (e.g., from another object, when placed in a pocket of a user), which may result in the UE 115-a being unable to receive or decode a paging message that may trigger an uplink transmission by the UE 115-a, or the UE 115-a may transmit the uplink transmission but the uplink transmission may be unsuccessful in reaching the network entity 105-a due to the poor coverage. For instance, the UE 115-a may be able to decode an SSB or SIBs associated with the network entity 105-a, or a paging message from the network entity 105-a, but an uplink transmission to the network entity 105-a may be unsuccessful in reaching the network entity 105-a due to the poor coverage. Additionally, or alternatively, the UE 115-a may be unsuccessful in determining a position of the UE 115-a due to poor GNSS signal quality, and the UE 115-a may be unable to successfully transmit an uplink message. As such, the UE 115-a may receive a pre-paging signal 215 from the network entity 105-a, which may assist the UE 115-a to obtain better coverage, for example, by indicating that the UE 115-a relocate to a different location.

In some examples, the pre-paging signal 215 may be a more robust signal type relative to a paging message, such that the UE 115-a may receive the pre-paging signal even in some poor coverage scenarios. For example, the pre-paging signal 215 may be transmitted in a wider bandwidth relative to a paging message, for a longer duration than a paging message, or both. In some cases, however, the UE 115-a may not be configured with a procedure for when to initiate monitoring for the pre-paging signal 215. For example, the UE 115-a may not be configured with a monitoring mechanism for each scenario that the UE 115-a may be operating in, such as when operating in an idle mode (e.g., an RRC idle mode), an inactive mode (e.g., an RRC inactive mode), or a connected mode (e.g., an RRC connected mode). As such, defining conditions during which the UE 115-a is to monitor for pre-paging signals 215 may be beneficial.

In accordance with examples as described herein, the network entity 105-a may transmit a message including an indication of a pre-paging configuration 205 (e.g., a pre-paging signal configuration 205) for the UE 115-a. The pre-paging configuration 205 may configure the UE 115-a with one or more conditions for when to monitor for a pre-paging signal 215 (e.g., from the network entity 105-a, or from any network entity 105). In some examples, the pre-paging configuration 205 may indicate the UE 115-a that it can monitor for pre-paging signals 215 from a cell (e.g., the network entity 105-a) without having received an SSB signal from the cell, that the UE 115-a is to monitor for pre-paging signals from the cell if the UE 115-a has received and decoded an SSB from the cell (e.g., only an SSB), or that the UE 115-a is to monitor for pre-paging signals from the cell if the UE 115-a has received and decoded an SSB from the cell and a paging message (e.g., a paging downlink control information (DCI) message). Additionally, or alternatively, the pre-paging configuration 205 may configure the UE 115-a to monitor for pre-paging signals 215 from a cell without having received or decoded one or more SIBs associated with the cell, or to monitor for pre-paging signals 215 from the cell (e.g., only) if the UE 115-a has (e.g., previously) received and stored valid SIBs from the cell.

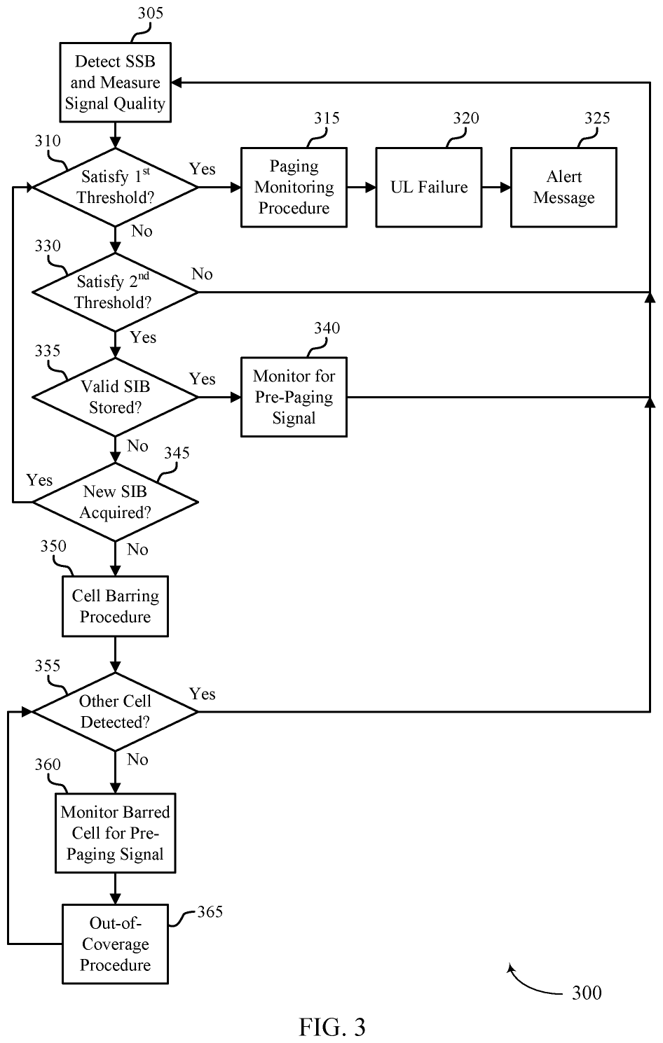

In some examples, the pre-paging configuration 205 may include one or more signal quality thresholds, which may indicate the UE 115-a when to monitor for a pre-paging signal based on which signal quality thresholds are satisfied. Additionally, or alternatively, the pre-paging configuration 205 may configure the UE 115-a to monitor for a pre-paging signal 215 based on an area 225. For instance, the UE 115-a may be configured to monitor for a pre-paging signal 215 if the UE 115-a is within the area 225, which may be a tracking area (e.g., an SIB tracking area, such as an SIB1 tracking area) associated with the network entity 105-a. Additionally, or alternatively, the UE 115-a may be configured to monitor for a pre-paging signal 215 from a barred cell if (e.g., and only if) the UE 115-a is within the area 225. Examples of these conditions for monitoring for a pre-paging signal 215 are depicted in more detail herein, with reference to FIG. 3.

Additionally, or alternatively, the pre-paging configuration 205 may configure the UE 115-a with one or more pre-paging modes. In some examples, a pre-paging mode may be associated with a list of one or more physical cell identifiers (PCIs) corresponding to a list of one or more cells for which the UE 115-a may monitor for a pre-paging signal 215. For example, the UE 115-a may monitor for a pre-paging signal 215 from the network entity 105-a if (e.g., and only if) a PCI corresponding to the network entity 105-a is included in the list of the pre-paging configuration 205 based on the pre-paging configuration (e.g., the pre-paging mode). If a PCI corresponding to the network entity 105-a is not included in the list, however, the UE 115-a may refrain from monitoring for pre-paging signals 215 from the network entity 105-a. Additionally, or alternatively, a pre-paging mode may be associated with a list of frequency bandwidths (e.g., frequency ranges, frequencies) for which the UE 115-a is configured to monitor for pre-paging signals 215. For example, the UE 115-a may monitor for a pre-paging signal 215 if (e.g., and only if) the UE 115-a is operating within a frequency bandwidth included in the list of frequency bandwidths. Additionally, or alternatively, the pre-paging mode may be associated with a geographical area, such that the UE 115-a may monitor for a pre-paging signal 215 if (e.g., and only if) the UE 115-a is within the geographical area.

In some examples, the pre-paging configuration 205 may define a gap period (e.g., an offset) between a transmission occasion for the pre-paging configuration 205 and a corresponding paging message. For example, the pre-paging configuration 205 may indicate that a pre-paging signal occasion is to occur one or more paging discontinuous reception (DRX) cycles prior to a paging message occasion. As such, if the UE 115-a receives a pre-paging signal 215, the gap period may provide some time for the UE 115-a to relocate to a different location which may have better coverage. Accordingly, the UE 115-a may receive the paging message (e.g., a paging DCI) directly, without performing a cell selection or reselection procedure.

In some cases, the network entity 105-a may transmit an indication of the pre-paging configuration 205 via an RRC message, such as via an RRC release message, or via system information (e.g., an SIB). In some cases, the area 225 may also be configured to the UE 115-a via the RRC message or the system information, in a same message as the pre-paging configuration 205, or in a separate message (e.g., after transmission of the pre-paging configuration 205 or prior to the transmissions of the pre-paging configuration 205). For example, the network entity 105-a may indicate a radius length and a center point (e.g., as coordinates in two or more dimensions) associated with the area 225.

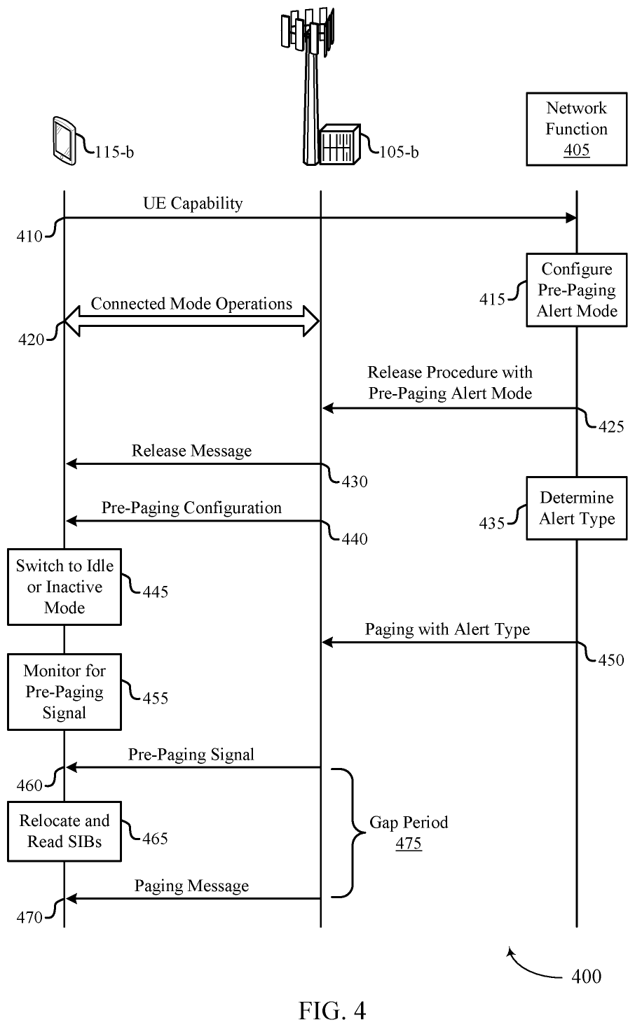

In some examples, the pre-paging configuration 205 may be configured (e.g., at least in part) by a network function, such as an access and mobility management function (AMF). The network function may be a part of the UE 115-a or may be included within a separate network entity 105, which may transmit an indication of the pre-paging configuration 205 to the network entity 105-a for forwarding to the UE 115-a. Communications with the network function are described in more detail with reference to FIG. 4.

In some cases, the pre-paging configuration 205 may be based on a capability of the UE 115-a. For example, the UE 115-a may transmit a capability message 210 indicating a capability of the UE 115-a associated with monitoring for a pre-paging signal 215. For example, the capability message 210 may report a capability of the UE 115-a to monitor for a pre-paging signal 215. For example, the capability message 210 may indicate that the UE 115-a can operate in a pre-paging alert mode that supports pre-paging signal monitoring in accordance with on one or more of the aspects described herein. Additionally, or alternatively, the capability message 210 may be or include an indication of whether the UE 115-a supports pre-paging signal monitoring. The pre-paging configuration 205 may configure the UE 115-a to operate in the one or more pre-paging alert modes based on receiving the capability message 210.

The UE 115-a may be configured with one or more actions to be performed based on detecting a pre-paging signal 215. For example, the UE 115-a may output an alert message 220 based on receiving a pre-paging signal 215 from the network entity 105-a. The alert message 220 may indicate (e.g., to a user of the UE 115-a) that the UE 115-a may be experiencing poor coverage. Additionally, or alternatively, the alert message 220 may indicate for the UE 115-a to be relocated to another location (e.g., by the user), to be moved away from interference, or to be removed from a pocket of the user, to improve coverage.

In some examples, if the UE 115-a is operating in a connected mode (e.g., an RRC connected mode), the UE 115-a may trigger a radio link failure (RLF) procedure. The UE 115-a may initiate an RRC reestablishment procedure based on triggering the RLF procedure. If the RRC reestablishment procedure is unsuccessful (e.g., fails), the UE 115-a may be configured (e.g., based on the pre-paging configuration 205, or separately) to output the alert message 220. In some examples, the UE 115-a may be triggered to output the alert message 220 based on a quantity of RRC reestablishment attempts performed by the UE 115-a (e.g., the quantity meeting or exceeding a threshold value), or based on the RRC reestablishment procedure being unsuccessful.

Additionally, or alternatively, the UE 115-a may also be triggered to output the alert message 220 based on an indication from the network entity 105-a. For example, the UE 115-a may be operating in the connected mode with the network entity 105-a, and the network entity 105-a may transmit an alert command to the UE 115-a that triggers the UE 115-a to output the alert message 220. As such, the UE 115-a may indicate (e.g., to a user) that relocating to another area may improve coverage. Further, the alert message 220 may be output while the UE 115-a is still in the connected mode, so the UE 115-a may be relocated without interrupting communications with the network entity 105-a or initiating an RLF procedure.

Accordingly, the pre-paging configuration 205 may configure the UE 115-a with one or more conditions associated with monitoring for pre-paging signals 215. Further, the UE 115-a may be configured to output an alert message 220, for example, based on receiving a pre-paging signal 215 and in accordance with the pre-paging configuration 205.

FIG. 3 shows an example of a flowchart 300 that supports pre-paging alert monitoring procedure in accordance with one or more aspects of the present disclosure. The flowchart 300 illustrates example decisions that may be considered by a device, such as a UE 115, to initiate monitoring for a pre-paging signal, as described herein. In some examples, steps may be added, omitted, or performed in a different order than as shown in the flowchart 300.

At 305, a UE 115 may detect an SSB associated with a cell (e.g., a suitable cell, a network entity 105), and the UE 115 may measure a signal quality associated with a connection with the cell. For example, the UE 115 may measure one or more reference signals, and the UE 115 may determine an RSRP value, an RSRQ value, or another signal quality value. In some examples, at 305, the UE 115 may have been configured for pre-paging procedures via a pre-paging configuration, as described herein with reference to FIG. 2.

At 310, the UE 115 may determine whether the measured signal quality satisfies (e.g., meets, exceeds) a criterion (e.g., a cell selection suitability criterion) associated with a cell selection procedure and monitoring for a paging message. For example, the criterion may include a first signal quality threshold (e.g., an RSRP threshold value, an RSRQ threshold value), which may be a minimum signal quality for which the UE 115 may be able to monitor for a paging message. If the signal quality satisfies the criterion (e.g., satisfies the first signal quality threshold), at 315, the UE 115 may perform a paging monitoring procedure. For example, the UE 115 may monitor for (e.g., regular) paging messages, and may perform idle mode (e.g., RRC idle mode) procedures. In some examples, at 320, the UE 115 may experience uplink failure 320. For example, the UE 115 may be unsuccessful in transmitting an uplink message for one or more reasons, such as poor coverage, and the UE 115 may trigger radio link failure procedures as described with reference to FIG. 2. In some cases, at 325, the UE 115 may output, based on the uplink failure, an alert message to indicate (e.g., to a user) that coverage is poor, or that relocating to a different location (e.g., a clear location) may improve coverage. In some examples, the UE 115 may initiate an RRC reestablishment procedure based on the uplink failure, and the UE 115 may output the alert message 325 based on the RRC reestablishment procedure. For instance, the UE 115 may output the alert message based on a quantity of RRC reestablishment attempts performed by the UE 115 (e.g., the quantity meeting or exceeding a threshold value), or based on the RRC reestablishment procedure being unsuccessful.

If the measured signal quality associated with the cell does not satisfy the first signal quality threshold, there may be a failure of the criterion associated with selection of the first cell of the cell (e.g., by the UE 115). As such, at 330, the UE 115 may determine whether the measured signal quality satisfies a second signal quality threshold. In some examples, the second signal quality threshold (e.g., an RSRP threshold value, an RSRQ threshold value) may be configured via the pre-paging configuration. If the measured signal quality satisfies the second signal quality threshold, at 340, the UE 115 may determine whether the UE 115 has one or more valid SIBs associated with the cell stored (e.g., in memory of the UE 115). For example, the UE 115 may check whether the UE 115 has valid SIBs stored for a current SSB or a frequency (e.g., for communications with the cell).

If the UE 115 determines that the UE 115 has stored one or more valid SIBs associated with the cell, at 340, the UE 115 may monitor for a pre-paging signal from the cell. In some cases, the UE 115 may monitor for the pre-paging signal in accordance with the pre-paging configuration. For example, the UE 115 may check whether one or more other conditions are satisfied, as described with reference to FIG. 2, to determine whether to monitor for the pre-paging signal. For instance, the UE 115 may monitor for the pre-paging signal if the UE 115 is located within a tracking area associated with the cell (e.g., an SIB tracking area, such as an SIB1 tracking area) that may be stored at the UE 115, or if the UE 115 is located within a geographical area configured by the pre-paging configuration. If the UE 115 detects the pre-paging signal, the UE 115 may output an alert message, as described herein.

If the UE 115 determines that the UE 115 does not have valid SIBs stored associated with the cell, at 345, the UE 115 may attempt to acquire one or more new SIBs from the cell. For example, the UE 115 may attempt to receive an SIB, such as an SIB1, an SIB 19, or both, from the cell. If the UE 115 successfully acquires the one or more SIBs, the UE 115 may return to step 310 and check whether a measured signal quality (e.g., a new signal quality measurement or a previous signal quality measurement) satisfies the first threshold signal quality.

If the UE 115 does not successfully acquire the one or more SIBs, the UE 115 may initiate a cell barring procedure to bar the cell. For example, the UE 115 may bar the cell such that the UE 115 may avoid selecting the cell for communications. In some examples, the UE 115 may bar the cell for a configured amount of time (e.g., configured by the pre-paging configuration or via other signaling). The UE 115 may initiate a cell detecting procedure to search for a different cell to connect to.

At 355, if the UE 115 detects a new cell, the UE 115 may return to step 305 and detect one or more SSBs associated with the new cell and measure a signal quality associated with the cell, and the UE 115 may perform steps of the flowchart 300 with respect to the new cell. If the UE 115 does not detect a new cell, at 360, the UE 115 may monitor the barred cell for a pre-paging signal. In some examples, the UE 115 may be configured (e.g., via the pre-paging configuration) with an area, such that the UE 115 may monitor the barred cell when the UE 115 is located within the area. For example, the area may be a tracking area, such as an SIB tracking area. If the UE 115 detects the pre-paging signal, the UE 115 may output an alert message, as described herein.

At 365, the UE 115 may perform an out-of-coverage procedure to search for a new cell. In some examples, the UE 115 may periodically search for a new cell while performing the out-of-coverage procedure. If the UE 115 detects a new cell, the UE 115 may return to step 305 and detect one or more SSBs associated with the new cell and measure a signal quality associated with the cell, and the UE 115 may perform steps of the flowchart 300 with respect to the new cell. In some cases, the UE 115 may perform monitoring for a pre-paging signal from the barred cell and the out-of-coverage procedure concurrently. For example, the UE 115 may perform monitoring for the pre-paging signal and monitoring for a signal from a new cell within overlapping occasions, at the same time, or during at least partially overlapping time occasions.

Accordingly, the UE 115 may be configured with a procedure to determine if or when to monitor for a pre-paging signal.

FIG. 4 shows an example of a process flow 400 that supports pre-paging alert monitoring procedure in accordance with one or more aspects of the present disclosure. The process flow 400 illustrates communications between a UE 115-b, a network entity 105-b, and a network function 405 (e.g., an AMF), which may be examples of corresponding devices and components and devices as described herein, with reference to FIGS. 1 through 3. In some examples, steps may be added or omitted to the process flow 400, and steps may be performed in different order than shown.

At 410, the UE 115-b may transmit a message indicating a capability of the UE 115-b to monitor for a pre-paging signal. The UE 115-b may transmit the message directly to the network function 405. Alternatively, the UE 115-b may transmit the message to the network entity 105-b, which may be an example of a cell as described herein, and the network entity 105-b may forward the capability of the UE 115-b to the network function 405.

At 415, the network function 405 may configure a pre-paging alert mode for the UE 115-b. For example, the network function 405 may generate a pre-paging configuration (e.g., a pre-paging signal configuration) for the UE 115-b. The pre-paging configuration may configure the UE 115-a with one or more conditions for when to monitor for a pre-paging signal (e.g., from the network entity 105-b, or from any network entity 105). In some examples, the pre-paging configuration may indicate the UE 115-b that it can monitor for pre-paging signals from the network entity 105-b without having received an SSB signal from the network entity 105-b, that the UE 115-b is to monitor for pre-paging signals from the cell if the UE 115-b has received and decoded an SSB from the network entity 105-b (e.g., only an SSB), or that the UE 115-b is to monitor for pre-paging signals from the network entity 105-b if the UE 115-b has received and decoded an SSB from the cell and a paging message (e.g., a paging downlink control information (DCI) message) from the network entity 105-b. Additionally, or alternatively, the pre-paging configuration may configure the UE 115-b to monitor for pre-paging signals from the network entity 105-b without having received or decoded one or more SIBs associated with the network entity 105-b, or to monitor for pre-paging signals from the network entity 105-b (e.g., only) if the UE 115-b has (e.g., previously) received and stored valid SIBs from the network entity 105-b.

In some examples, the pre-paging configuration may include one or more signal quality thresholds, which may indicate the UE 115-b when to monitor for a pre-paging signal based on which signal quality thresholds are satisfied, as described herein with reference to FIG. 3. Additionally, or alternatively, the pre-paging configuration may configure the UE 115-b to operate with a pre-paging mode, which may be associated with a geographical area. For instance, the UE 115-b may be configured to monitor for a pre-paging signal if the UE 115-b is within the geographical area, which may be a tracking area (e.g., an SIB tracking area, such as an SIB1 tracking area) associated with the network entity 105-b. Additionally, or alternatively, the pre-paging mode may configure the UE 115-b with a list of one or more physical cell identifiers (PCIs) corresponding to a list of one or more cells for which the UE 115-b may monitor for a pre-paging signal 215. For example, the UE 115-b may monitor for a pre-paging signal from the network entity 105-b if (e.g., and only if) a PCI corresponding to the network entity 105-a is included in the list of the pre-paging configuration 205. Additionally, or alternatively, the pre-paging mode may be associated with a list of frequencies for which the UE 115-b is configured (e.g., allowed) to monitor for pre-paging signals.

At 420, the UE 115-b and the network entity 105-b may be performing connected mode (e.g., RRC connected mode) operations. For example, the network entity 105-b may transmit paging messages to the UE 115-b, and the UE 115-b may transmit uplink messages in response. In some examples, the UE 115-b may trigger an RLF procedure while in connected mode. In some cases, after triggering the RLF procedure, the UE 115-b may trigger an RRC reestablishment procedure. If the RRC reestablishment procedure is unsuccessful, the UE 115-b may be configured to output an alert message. For instance, if a quantity of RRC reestablishment attempts satisfies a threshold, the UE 115-b may output the alert message. Additionally, or alternatively, the UE 115-b may output the alert message if the RRC reestablishment procedure fails.

At 425, the network function 405 may initiate a release procedure for the UE 115-b, which may release the UE 115-b from the network entity 105-b. In some examples, the network function 405 may transmit a message to the network entity 105-b such that the network entity 105-b forwards a release message to the network entity 105-b. In some examples, the network function 405 may include an indication of the pre-paging alert mode, the pre-paging configuration, or both, in the message to the network entity 105-b. Alternatively, the network function 405 may transmit a separate message indicating the pre-paging alert mode. At 430, the network entity 105-b may transmit the release message (e.g., an RRC release message) to the UE 115-b.

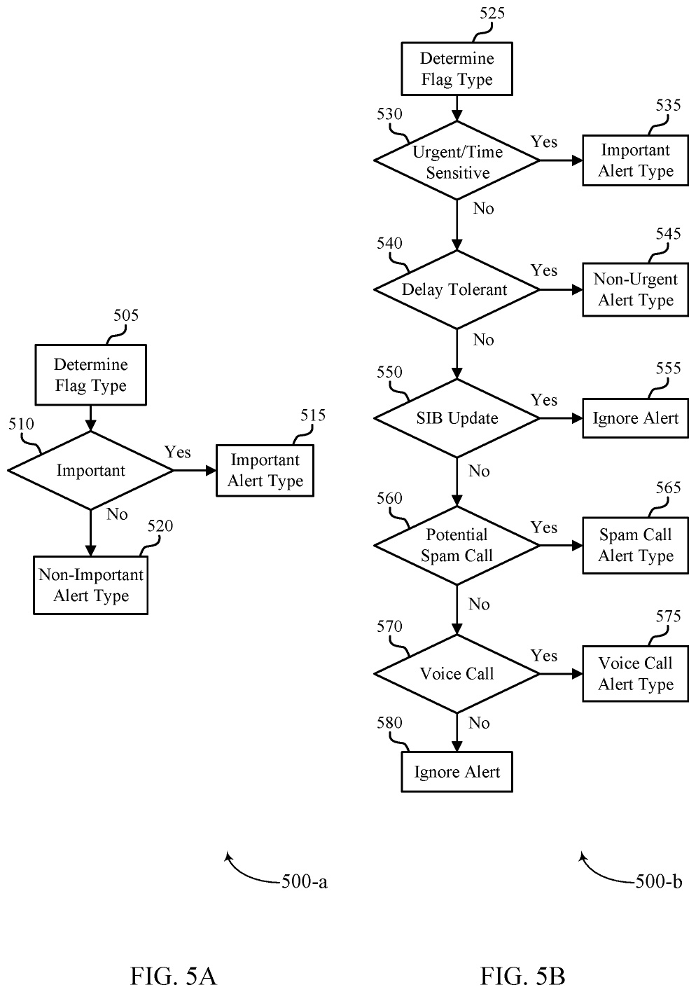

At 435, the network function 405 may determine an alert type. For example, the network function 405 may obtain data for the UE 115-b (e.g., mobile terminated (MT) data), and the network function 405 may determine an alert type corresponding to the data. In some examples, the network function 405 may select an alert type from a set of alert types. The set of data types may include an important alert type, an emergency alert type, a non-important alert type, a silent alert type, or other alert types, which are described in more detail with reference to FIGS. 5A and 5B.

At 440, the network entity 105-b may transmit a message indicating the pre-paging configuration to the UE 115-b. In some examples, the message may include an indication of the geographical area for which the pre-paging configuration may apply. Alternatively, the network entity 105-b may transmit a separate message indicating the area configuration that configures the UE 115-b with the geographical area, for example, in the form of a center coordinate and a radius.

At 445, the UE 115-b may switch to an idle or inactive mode (e.g., RRC idle or RRC inactive) based on receiving the release message. In some examples, switching to the idle or inactive mode may involve barring the network entity 105-b via a barring procedure.

At 450, the network function 405 may transmit an indication of a paging message for the UE 115-b to the network entity 105-b. In some examples, the indication may indicate an alert type associated with the paging message.

At 455, the UE 115-b may monitor for a pre-paging signal 455. For example, the UE 115-b may monitor for a paging signal from the barred network entity 105-b based on the UE 115-b not acquiring a new cell, as described with reference to FIG. 3. In some cases, the UE 115-b may monitor for the pre-paging signal based on being within the geographical area configured to the UE 115-b.

At 460, the network entity 105-b may transmit the pre-paging signal to the UE 115-b. In some examples, the pre-paging signal may be transmitted on a time occasion based on a gap period 475 relative to a time occasion for a paging message. In some examples, the pre-paging configuration may indicate the gap period 475 (e.g., as one or more DRX cycles) to the UE 115-b, such that the UE 115-b may monitor the corresponding time occasion for the pre-paging signal. In some cases, the pre-paging signal may include an indication of the alert type selected by the network function 405. The UE 115-b may receive the pre-paging signal and may output an alert message associated with (e.g., based on, in response to) receiving the pre-paging signal, as described herein. For example, the UE 115-b may output an alert message, which may be a notification (e.g., for a user) which indicates that the UE 115-b is experiencing poor coverage, that the UE 115-b should be relocated to improve coverage, or both. In some examples, the alert message may be outputted based on the alert type selected by the network function 405, as described in more detail with reference to FIGS. 5A and 5B.

At 465, the UE 115-b may relocate to a different location, for example, based on outputting the alert message, which may improve the coverage of the network entity 105-b received by the UE 115-b. The UE 115-b may read one or more SIBs associated with the network entity 105-b, and, at 470, the UE 115-b may read the paging message (e.g., paging DCI). In some examples, the gap period 475 may be configured such as to provide sufficient time for the UE 115-b to find better coverage and detect the paging message. Accordingly, the UE 115-b may receive the paging message from the network entity 105-b based on receiving the pre-paging signal without performing a cell selection or reselection procedure.

FIG. 5A shows an example of a flowchart 500-a that supports pre-paging alert monitoring procedure in accordance with one or more aspects of the present disclosure. The flowchart 500-a illustrates example decisions that may be considered by a device, such as a UE 115, to determine an alert type for an alert message associated with a detected pre-paging signal. In some examples, steps may be added to or omitted from the flowchart 500-a, or steps may be performed in a different order than as shown in the flowchart 500-a.

The flowchart 500-a illustrates an example where the pre-paging signal may include an indication of a flag type, such as an important flag type (e.g., an emergency flag type, an urgent flag type). For example, at 505 the UE 115 may determine a flag type indicated by the pre-paging signal. At 510, the UE 115 may determine whether the flag type indicates that data associated with a paging message corresponding to the pre-paging signal is important. For example, the pre-paging signal may indicate using a flag (e.g., as one or more bits) that the data associated with the corresponding paging message is important.

If the UE 115 determines that the data is important based on an important flag type, at 515, the UE 115 may output an alert message using an important alert type. For example, the important alert type may correspond to an audible (e.g., a ringing) notification, a vibration notification, a text notification (e.g., a pop-up notification), or another type of notification that may be prompted by the UE 115 to a user. In some examples, the important flag type may be used in pre-paging signals corresponding to data for earthquake and tsunami warning system (ETWS) messages, commercial mobile alert system (CMAS) messages, genuine voice calls (e.g., non-spam voice calls, voice calls from contacts, voice calls from important or starred contacts), time sensitive data, other important data, or a combination thereof.

If the UE 115 determines that the data is not important based on a non-important flag type, at 520, the UE 115 may output an alert message using an unimportant alert type. In some examples, the unimportant alert type may indicate the UE 115 to refrain from outputting the alert message at all. Alternatively, the UE 115 may output the alert message using a silent notification (e.g., non-audible and non-vibrate), or another type of notification. In some examples, the non-important flag type may be used in pre-paging signals corresponding to data for potential spam calls, delay tolerant data, system information updates, other non-time sensitive data, or a combination thereof.

FIG. 5B shows an example of a flowchart 500-b that supports pre-paging alert monitoring procedure in accordance with one or more aspects of the present disclosure. The flowchart 500-b illustrates example decisions that may be considered by a device, such as a UE 115, to determine an alert type for an alert message associated with a detected pre-paging signal. In some examples, steps may be added to or omitted from the flowchart 500-b, or steps may be performed in a different order than as shown in the flowchart 500-b.

The flowchart 500-b illustrates an example where the pre-paging signal may include an indication of a flag type, which may be selected from a set of flag types. Relative to the flowchart 500-a, the flowchart 500-b illustrates the use of a larger quantity of flag types, allowing for the UE 115 to select from one of a larger quantity of alert types. For example, at 525 the UE 115 may determine a flag type indicated by the pre-paging signal. While the flowchart 500-b shows an example corresponding to five different flag types, each with a corresponding alert type, different quantities of flag types and alert types may also be used in different examples.

At 530, the UE 115 may determine whether the flag type corresponds to urgent or time sensitive data. For example, the pre-paging signal may indicate using a flag (e.g., as one or more bits) that the data associated with the corresponding paging message is urgent or time sensitive. If the flag type corresponds to urgent or time sensitive data, at 535, the UE 115 may output an alert message using an important alert type. For example, the important alert type may correspond to an audible (e.g., a ringing) notification, a vibration notification, a text notification (e.g., a pop-up notification), or another type of notification that may be prompted by the UE 115 to a user. In some examples, the important flag type may be used in pre-paging signals corresponding to data for earthquake and tsunami warning system (ETWS) messages, commercial mobile alert system (CMAS) messages, important voice calls (e.g., voice calls from contacts, voice calls from important or starred contacts), time sensitive data, other important data, or a combination thereof.

At 540, the UE 115 may determine whether the flag type corresponds to delay tolerant data. For example, the pre-paging signal may indicate using a flag (e.g., as one or more bits) that the data associated with the corresponding paging message is delay tolerant. If the flag type corresponds to delay tolerant data, at 545, the UE 115 may output an alert message using a non-urgent alert type. For example, the important alert type may correspond to a vibration notification, a text notification (e.g., text-only, a pop-up notification), or another type of notification that may be prompted by the UE 115 to a user. In some examples, the non-urgent flag type may be used in pre-paging signals corresponding to non-urgent data, such as text messages, non-urgent voice calls (e.g., from non-starred contacts, or from non-contacts), other non-urgent data, or a combination thereof.

At 550, the UE 115 may determine whether the flag type corresponds to delay an SIB Update. For example, the pre-paging signal may indicate using a flag (e.g., as one or more bits) that the data associated with the corresponding paging message is associated with a change in an SIB associated with a serving cell. If the flag type corresponds to an SIB update, at 555, the UE 115 may ignore outputting the alert message. For example, the UE 115 may refrain from outputting an alert message in response to receiving the pre-paging signal if the flag type corresponds to an SIB update.

At 560, the UE 115 may determine whether the flag type corresponds to a potential spam call. For example, the pre-paging signal may indicate using a flag (e.g., as one or more bits) that the data associated with the corresponding paging message corresponds to a spam call (e.g., a potential spam call). If the flag type corresponds to a potential spam call, at 565, the UE 115 may output an alert message using a spam call alert type. In some cases, the spam call alert type may correspond to a silent notification, a text notification (e.g., text-only, a pop-up notification), or another type of notification that may be prompted by the UE 115 to a user. Alternatively, the UE 115 may also refrain from outputting an alert message based on the flag type corresponding to a potential spam call.

At 570, the UE 115 may determine whether the flag type corresponds to a voice call. For example, the pre-paging signal may indicate using a flag (e.g., as one or more bits) that the data associated with the corresponding paging message corresponds to a voice call (e.g., a potential spam call). If the pre-paging signal indicates a voice call flag type, at 575, the UE 115 may output an alert message using a voice call alert type. In some cases, the voice call alert type may correspond to a ring notification, a vibrate notification, a text notification, or another type of notification that may be prompted by the UE 115 to a user.

In some examples, at 580, if the flag type does not correspond to an alert type configured at the UE 115, or if the pre-paging signal does not indicate an alert type, the UE 115 may ignore the alert. For example, the UE 115 may refrain from outputting an alert message. Alternatively, the UE 115 may output an alert message using a default alert type, which may be one of the alert types described herein.

While the alert types are described herein with respect to downlink paging data available for the UE 115, the alert types may also be used by the UE 115 for uplink data. For example, if the UE 115 has uplink data for transmission but is experiencing poor coverage, the UE 115 may output an alert message based on the uplink data to be transmitted. In some examples, the UE 115 may follow a procedure similar to that depicted in the flowchart 500-b for selecting an alert type but based on an event associated with an uplink message.

For example, if the UE 115 determines that the UE 115 has been in a cell selection state (e.g., any cell selection state, such as a cell selection or reselection state), the UE 115 may output an alert message using a soft alert type (e.g., a vibration alert, a text alert). The UE 115 may determine that the UE 115 is experiencing poor coverage while communicating user initiated traffic, such as a voice call, and the UE 115 may output an alert message using a text alert type. In another example, the UE 115 may determine that a registration update has occurred, and the UE 115 may output an alert message if the UE 115 determines that a pre-paging signal will not be received in the current cell due to the registration update. In some cases, the UE 115 may determine that it is experiencing poor coverage when communicating delay tolerant uplink data, and the UE 115 may refrain from outputting an alert message. Additionally, or alternatively, the UE 115 may determine that it is experiencing poor coverage when communicating important uplink data, and the UE 115 may determine to output an alert message using a configured alert type (e.g., an important alert type). In another example, the UE may be operating in connected mode and determine that the UE 115 is experiencing poor coverage (e.g., due to RLF), and the UE 115 may output an alert message with a configured alert type (e.g., a text alert or a vibration alert).

The alert types corresponding to each flag type or uplink event are exemplary, and, in some examples, the UE 115 may be configured with different alert types for any of the flag types or uplink data types described herein. Further, in some cases, the UE 115 may modify which alert type corresponds to a flag type. For example, the UE 115 may allow a user to configure the UE 115 with an alert type for each flag type, allowing the UE 115 to be configured with different alert types. In some cases, for example, the UE 115 may be configured to not output alert messages at all, or to output alert messages using a silent alert type. Additionally, or alternatively, a network entity 105, such as a cell, may transmit one or more messages to configure alert types corresponding to each flag type, to modify the configured alert types, or both.

Accordingly, by including flag type information in the pre-paging signal, the UE 115 may output different alert messages based on the type of data that corresponds to the pre-paging signal.

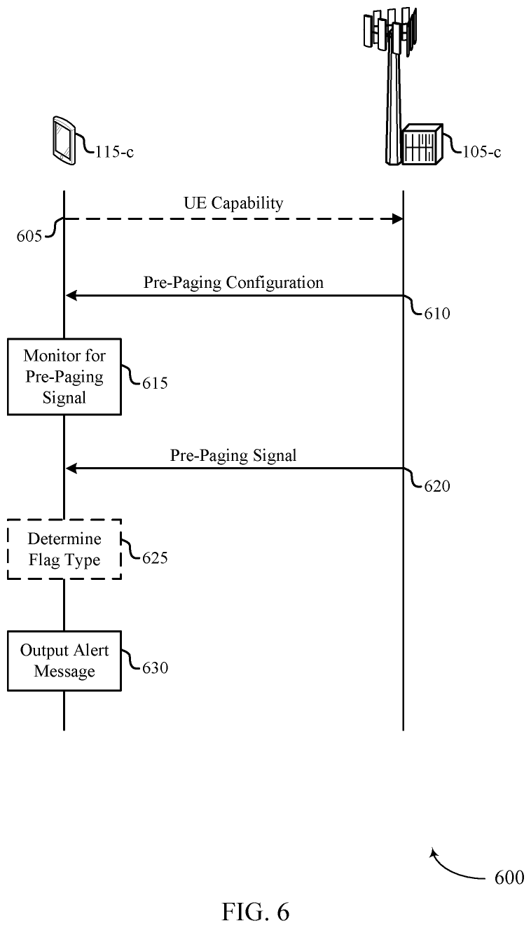

FIG. 6 shows an example of a process flow 600 that supports pre-paging alert monitoring procedure in accordance with one or more aspects of the present disclosure. The process flow 600 illustrates communications between a UE 115-c, and a network entity 105-c (e.g., a cell), which may be examples of corresponding devices and components and devices as described herein, with reference to FIGS. 1 through 5B. In some examples, steps may be added or omitted to the process flow 600, and steps may be performed in different order than shown.

At 605, the UE 115-c may transmit a message indicating a capability of the UE 115-c associated with monitoring for pre-paging signals. In some examples, the capability of the UE 115-c may indicate one or more pre-paging modes that may be supported by the UE 115-c. For example, the pre-paging modes may be associated with a list of PCIs for which to monitor for pre-paging signals, a list of frequencies for which to monitor for pre-paging signals, a geographical area in which the UE 115-c may monitor for pre-paging signals, one or more conditions to be satisfied that may trigger the UE 115-c to monitor for pre-paging signals, or a combination thereof. Additionally, or alternatively, the capability may indicate whether the UE 115-c supports monitoring for pre-paging signals at all.

At 610, the network entity 105-c may transmit a message indicating a pre-paging configuration (e.g., a pre-paging signal configuration). In some examples, the pre-paging configuration may be based on the capability of the UE 115-c. For example, the pre-paging configuration may indicate the UE 115-c to operate based on a pre-paging mode indicated within the capability of the UE 115-c. Additionally, or alternatively, the pre-paging configuration may indicate one or more conditions to be satisfied for the UE 115-c to initiate monitoring for pre-paging signals. In some examples, the pre-paging configuration may be transmitted via an RRC message that indicates the pre-paging configuration.

At 615, the UE 115-c may monitor for a pre-paging signal in accordance with the pre-paging configuration. For example, the UE 115-c may monitor for the pre-paging signal in response to one or more conditions being satisfied, the one or more conditions being based on the pre-paging configuration, where the one or more conditions include failure to satisfy a criterion associated with selection of the first cell (e.g., a cell selection procedure, a cell reselection procedure). In some examples, the one or more conditions may include a threshold value (e.g., a threshold RSRP value, a minimum RSRP value) for an RSRP measured by the UE 115-c. In some examples, the one or more conditions being satisfied may include the UE 115-c being with an SIB tracking area associated with the network entity 105-c, or within a geographical area configured by the pre-paging signal configuration. Additionally, or alternatively, the one or more conditions being satisfied may include the UE 115-c operating without having received a SSB signal associated with the network entity 105-c, the UE 115-c operating having received the SSB signal, or the UE 115-c operating having received the SSB signal and paging DCI associated with the network entity 105-c. In some examples, the one or more conditions being satisfied may additionally or alternatively include the UE 115-c operating without having obtained one or more valid SIBs associated with the network entity 105-c, or the UE 115-c operating having obtained one or more valid SIBs associated with the network entity 105-c.

At 620, the UE 115-c may receive the pre-paging signal associated with a corresponding paging message from the network entity 105-c. In some examples, the pre-paging signal may be transmitted based on a time offset from paging message. For example, the pre-paging signal may be transmitted, by the network entity 105-b, on a first occasion prior to a second occasion associated with the paging message based on the time offset. In some cases, the time offset may be indicated within the pre-paging configuration.

At 625, the UE 115-c may determine a flag type based on receiving the pre-paging signal. For example, the pre-paging signal may include information that indicates a flag type associated with data available for reception by the UE 115-c. The flag type may correspond to a type of information associated with the paging message. For example, the flag type may indicate whether the information is important or non-important. Additionally, or alternatively, the flag type may provide a more specific indication of the type of information, and the flag type may be a voice call flag type, a spam call flag type, a registration update flag type, delay tolerant uplink data flag type, important uplink data flag type, a connected mode flag type, or a flag type associated with the UE 115-c being in a cell selection state for a duration exceeding a threshold duration, or other flag types as described with reference to FIG. 5.

At 630, the UE 115-c may output an alert message associated with receiving the pre-paging signal. The alert message may indicate (e.g., to a user) for the UE 115-c to be relocated to a different physical location, which may improve coverage. In some examples, the alert message may be outputted based on the determined flag type. For example, each flag type may correspond to at least one alert type of a plurality of alert types, and the plurality of alert types may include a silent alert message, a vibration alert message, a ring alert message, an omitted alert message, or other alert types as described with reference to FIG. 5. The alert message may be outputted based on the corresponding alert type.

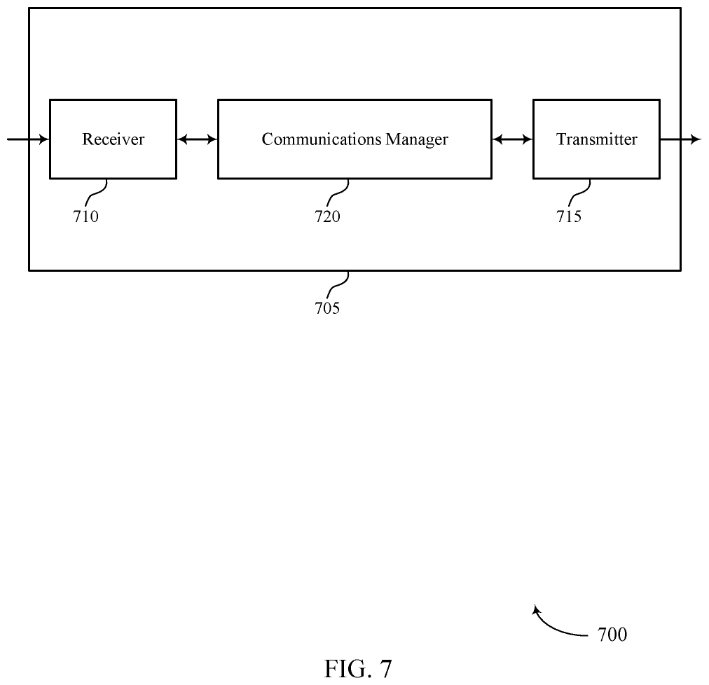

FIG. 7 shows a block diagram 700 of a device 705 that supports pre-paging alert monitoring procedure in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to pre-paging alert monitoring procedure). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to pre-paging alert monitoring procedure). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of pre-paging alert monitoring procedure as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving an indication of a pre-paging signal configuration for reception of a pre-paging signal associated with a first cell. The communications manager 720 is capable of, configured to, or operable to support a means for monitoring for the pre-paging signal from the first cell in response to one or more conditions being satisfied, where the one or more conditions for monitoring the pre-paging signal are associated with (e.g., based on) the pre-paging signal configuration, and where the one or more conditions for monitoring the pre-paging signal being satisfied includes failure of a criterion associated with selection of the first cell via a cell selection procedure (e.g., cell reselection). The communications manager 720 is capable of, configured to, or operable to support a means for receiving, based on the monitoring, the pre-paging signal from the first cell. The communications manager 720 is capable of, configured to, or operable to support a means for outputting an alert message associated with receiving the pre-paging signal.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for pre-paging signal monitoring which may facilitate improvement of coverage, thereby increasing the utilization of communication resources.

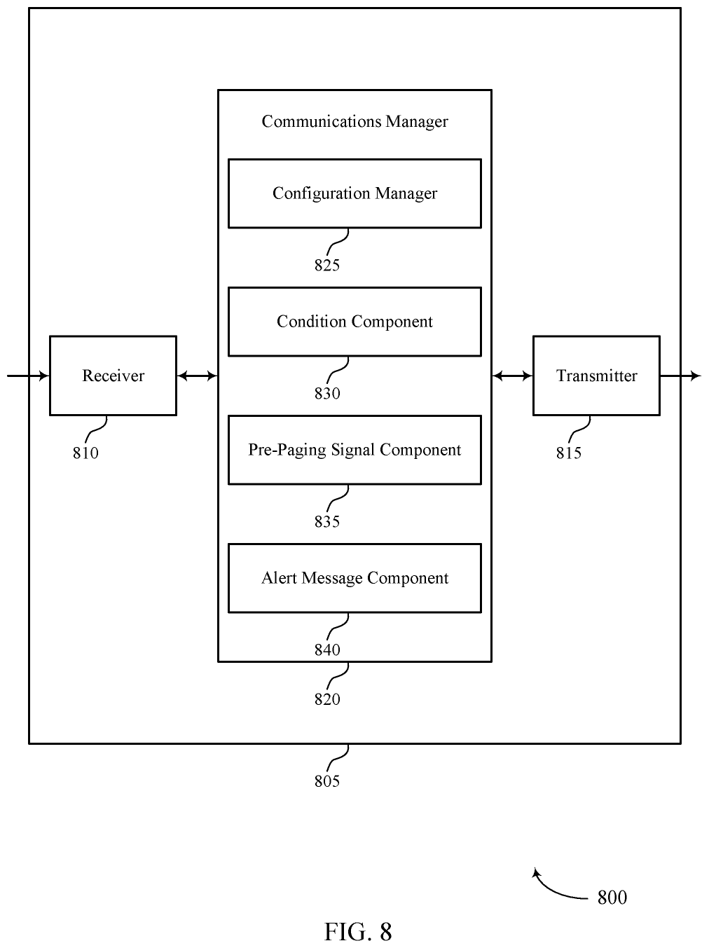

FIG. 8 shows a block diagram 800 of a device 805 that supports pre-paging alert monitoring procedure in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to pre-paging alert monitoring procedure). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to pre-paging alert monitoring procedure). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of pre-paging alert monitoring procedure as described herein. For example, the communications manager 820 may include a configuration manager 825, a condition component 830, a pre-paging signal component 835, an alert message component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration manager 825 is capable of, configured to, or operable to support a means for receiving an indication of a pre-paging signal configuration for reception of a pre-paging signal associated with a first cell. The condition component 830 is capable of, configured to, or operable to support a means for monitoring for the pre-paging signal from the first cell in response to one or more conditions being satisfied, where the one or more conditions for monitoring the pre-paging signal are associated with the pre-paging signal configuration, and where the one or more conditions for monitoring the pre-paging signal being satisfied include failure of a criterion associated with selection of the first cell via a cell selection procedure. The pre-paging signal component 835 is capable of, configured to, or operable to support a means for receiving, based on the monitoring, the pre-paging signal from the first cell. The alert message component 840 is capable of, configured to, or operable to support a means for outputting an alert message associated with receiving the pre-paging signal.

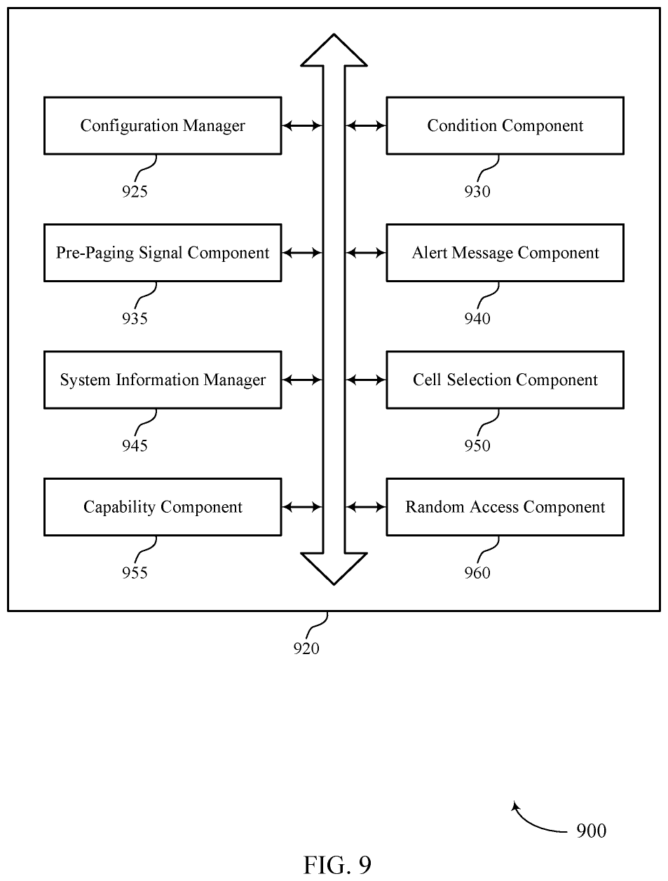

FIG. 9 shows a block diagram 900 of a communications manager 920 that supports pre-paging alert monitoring procedure in accordance with one or more aspects of the present disclosure. The communications manager 920 may be an example of aspects of a communications manager 720, a communications manager 820, or both, as described herein. The communications manager 920, or various components thereof, may be an example of means for performing various aspects of pre-paging alert monitoring procedure as described herein. For example, the communications manager 920 may include a configuration manager 925, a condition component 930, a pre-paging signal component 935, an alert message component 940, a system information manager 945, a cell selection component 950, a capability component 955, a random access component 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration manager 925 is capable of, configured to, or operable to support a means for receiving an indication of a pre-paging signal configuration for reception of a pre-paging signal associated with a first cell. The condition component 930 is capable of, configured to, or operable to support a means for monitoring for the pre-paging signal from the first cell in response to one or more conditions being satisfied, where the one or more conditions for monitoring the pre-paging signal are associated with the pre-paging signal configuration, and where the one or more conditions for monitoring the pre-paging signal being satisfied includes failure of a criterion associated with selection of the first cell via a cell selection procedure. The pre-paging signal component 935 is capable of, configured to, or operable to support a means for receiving, based on the monitoring, the pre-paging signal from the first cell. The alert message component 940 is capable of, configured to, or operable to support a means for outputting an alert message associated with receiving the pre-paging signal.

In some examples, the condition component 930 is capable of, configured to, or operable to support a means for measuring a reference signal to obtain a reference signal received power, where the failure of the criterion associated with selection of the first cell is or includes the reference signal received power failing to satisfy a first threshold value associated with monitoring for a paging message from the first cell.

In some examples, the one or more conditions being satisfied further includes the reference signal received power satisfying a second threshold value that is lower than the first threshold value.

In some examples, the one or more conditions include a second threshold value that is lower than the first threshold value. In some examples, monitoring for the pre-paging signal is based on the reference signal received power satisfying the second threshold value and failing to satisfy the first threshold value.

In some examples, the system information manager 945 is capable of, configured to, or operable to support a means for storing data associated with one or more system information blocks for the first cell, where monitoring for the pre-paging signal is based on storing the data associated with the one or more system information blocks.

In some examples, the one or more conditions being satisfied includes the UE being within a system information block tracking area associated with the one or more system information blocks.

In some examples, the system information manager 945 is capable of, configured to, or operable to support a means for monitoring, in response to at least one condition of the one or more conditions being satisfied, for one or more system information blocks associated with the first cell. In some examples, the cell selection component 950 is capable of, configured to, or operable to support a means for performing a cell barring procedure to bar the first cell based on failing to detect the one or more system information blocks.

In some examples, the cell selection component 950 is capable of, configured to, or operable to support a means for performing, after performing the cell barring procedure to bar the first cell, a cell detection procedure for a second cell, where monitoring for the pre-paging signal from the first cell is based on failing to detect the second cell via the cell detection procedure. In some examples, the one or more conditions being satisfied includes the UE being with a geographical area indicated by the pre-paging signal configuration.

In some examples, the capability component 955 is capable of, configured to, or operable to support a means for transmitting a capability message indicating a capability of the UE to operate in accordance with one or more pre-paging modes, where receiving the indication of the pre-paging signal configuration is associated with capability of the UE.

In some examples, the pre-paging signal configuration indicates at least one pre-paging mode in accordance with the capability of the UE. In some examples, the pre-paging mode is associated with a set of one or more physical cell identifiers, a set of one or more frequency bandwidths, a set of one or more geographical areas, or any combination thereof associated with monitoring for the pre-paging signal. In some examples, monitoring for the pre-paging signal is based on the pre-paging mode.

In some examples, the one or more conditions being satisfied includes the UE operating without having received a synchronization signal block signal associated with the first cell, the UE operating having received the synchronization signal block signal, or the UE operating having received the synchronization signal block signal and paging downlink control information associated with the first cell.

In some examples, the one or more conditions being satisfied includes the UE operating without having obtained one or more valid system information blocks associated with the first cell or the UE operating having obtained one or more valid system information blocks associated with the first cell. In some examples, the pre-paging signal configuration indicates a time offset between a pre-paging occasion for receiving the pre-paging signal and a corresponding paging occasion for receiving a paging message, from the first cell, corresponding to the pre-paging signal.

In some examples, to support receiving the indication of the pre-paging signal configuration, the configuration manager 925 is capable of, configured to, or operable to support a means for receiving a radio resource control message that indicates the pre-paging signal configuration.

In some examples, the random access component 960 is capable of, configured to, or operable to support a means for initiating a random access procedure for communications with the first cell based on receiving the pre-paging signal. In some examples, the pre-paging signal indicates a flag type of a set of multiple flag types. In some examples, the alert message is output based on the flag type.

In some examples, the set of multiple flag types includes at least one of a voice call flag type, a spam call flag type, a registration update flag type, delay tolerant uplink data flag type, important uplink data flag type, a connected mode flag type, or a flag type associated with the UE being in a cell selection state for a duration exceeding a threshold duration.

In some examples, each flag type of the set of multiple flag types corresponds to at least one alert type of a set of multiple alert types, the set of multiple alert types including a silent alert message, a vibration alert message, a ring alert message, and an omitted alert message. In some examples, the alert message corresponds to the indicated flag type.

In some examples, the cell selection component 950 is capable of, configured to, or operable to support a means for initiating a radio resource control reestablishment procedure based on triggering a radio link failure procedure while operating in a connected mode, where outputting the alert message is based on initiating the radio resource control reestablishment procedure.

In some examples, the alert message is output based on a quantity of radio resource control reestablishment procedure attempts exceeding a threshold quantity of attempts. In some examples, the alert message is output based on the radio resource control reestablishment procedure being unsuccessful. In some examples, the alert message indicates for the UE to be relocated to a different physical location.

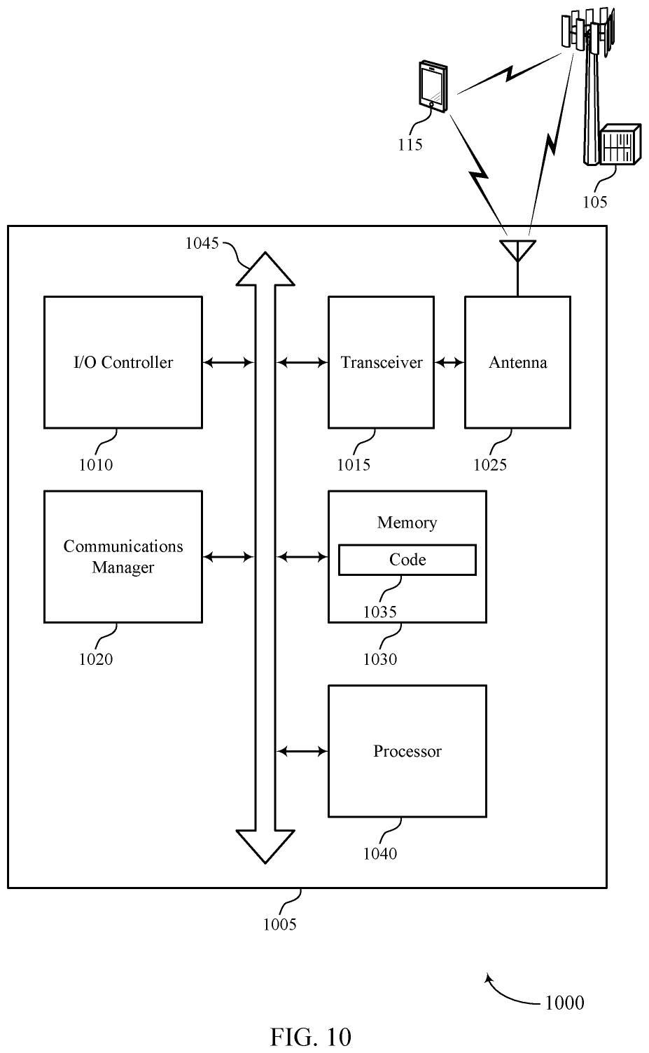

FIG. 10 shows a diagram of a system 1000 including a device 1005 that supports pre-paging alert monitoring procedure in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable (e.g., processor-executable) code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting pre-paging alert monitoring procedure). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. As such, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving an indication of a pre-paging signal configuration for reception of a pre-paging signal associated with a first cell. The communications manager 1020 is capable of, configured to, or operable to support a means for monitoring for the pre-paging signal from the first cell in response to one or more conditions being satisfied, where the one or more conditions for monitoring the pre-paging signal are associated with the pre-paging signal configuration, and where the one or more conditions for monitoring the pre-paging signal being satisfied includes failure of a criterion associated with selection of the first cell via a cell selection procedure. The communications manager 1020 is capable of, configured to, or operable to support a means for receiving, based on the monitoring, the pre-paging signal from the first cell. The communications manager 1020 is capable of, configured to, or operable to support a means for outputting an alert message associated with receiving the pre-paging signal.

By including or configuring the communications manager 1020 in accordance with examples as described herein, the device 1005 may support techniques for reception of pre-paging monitoring signals leading to improved utilization of communication resources due to improvements in coverage.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of pre-paging alert monitoring procedure as described herein, or the at least one processor 1040 and the at least one memory 1030 may be otherwise configured to, individually or collectively, perform or support such operations.

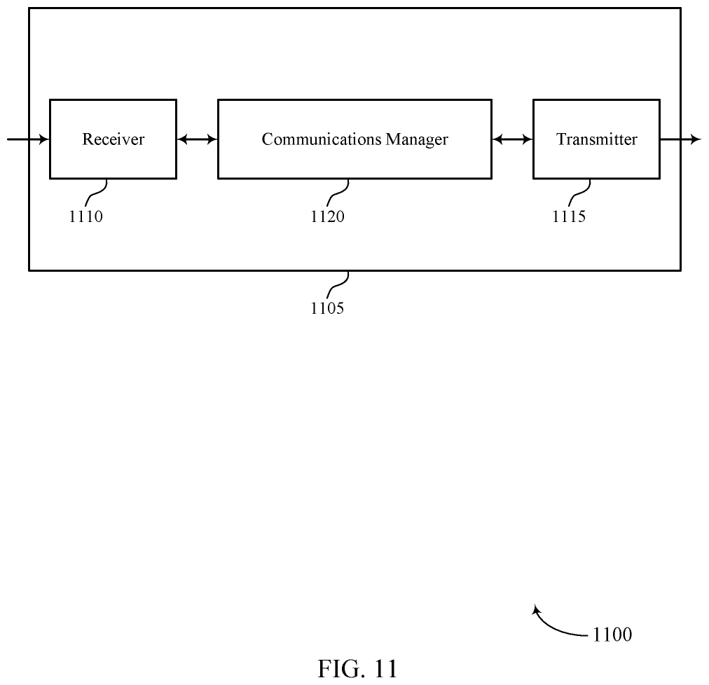

FIG. 11 shows a block diagram 1100 of a device 1105 that supports pre-paging alert monitoring procedure in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of pre-paging alert monitoring procedure as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting, to a UE, an indication of a pre-paging signal configuration associated with monitoring by the UE for a pre-paging signal associated with a first cell, where the monitoring for the pre-paging signal is dependent on satisfaction of one or more conditions that are associated with (e.g., based on) the pre-paging signal configuration, and where the one or more conditions include failure of a criterion associated with selection of the first cell via a cell selection procedure. The communications manager 1120 is capable of, configured to, or operable to support a means for transmitting, to the UE and via the first cell, the pre-paging signal in accordance with the pre-paging signal configuration, where the pre-paging signal indicates that the UE is to output an alert message.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reception of pre-paging monitoring signals leading to improved utilization of communication resources due to improvements in coverage.

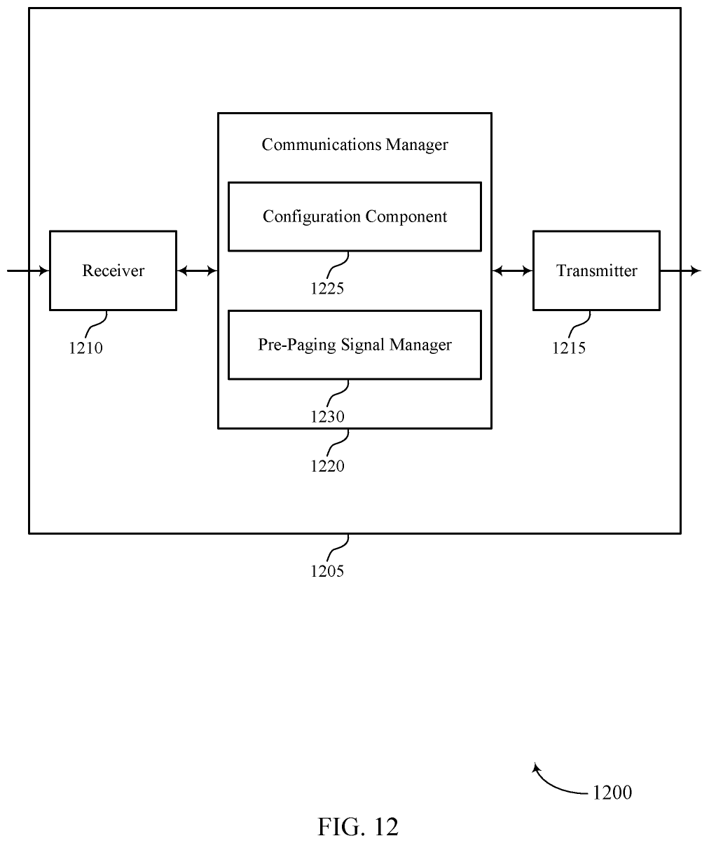

FIG. 12 shows a block diagram 1200 of a device 1205 that supports pre-paging alert monitoring procedure in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of pre-paging alert monitoring procedure as described herein. For example, the communications manager 1220 may include a configuration component 1225 a pre-paging signal manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration component 1225 is capable of, configured to, or operable to support a means for transmitting, to a UE, an indication of a pre-paging signal configuration associated with monitoring by the UE for a pre-paging signal associated with a first cell, where the monitoring for the pre-paging signal is dependent on satisfaction of one or more conditions that are associated with the pre-paging signal configuration, and where the one or more conditions include failure of a criterion associated with selection of the first cell via a cell selection procedure (e.g., by the UE). The pre-paging signal manager 1230 is capable of, configured to, or operable to support a means for transmitting, to the UE and via the first cell, the pre-paging signal in accordance with the pre-paging signal configuration, where the pre-paging signal indicates that the UE is to output an alert message.

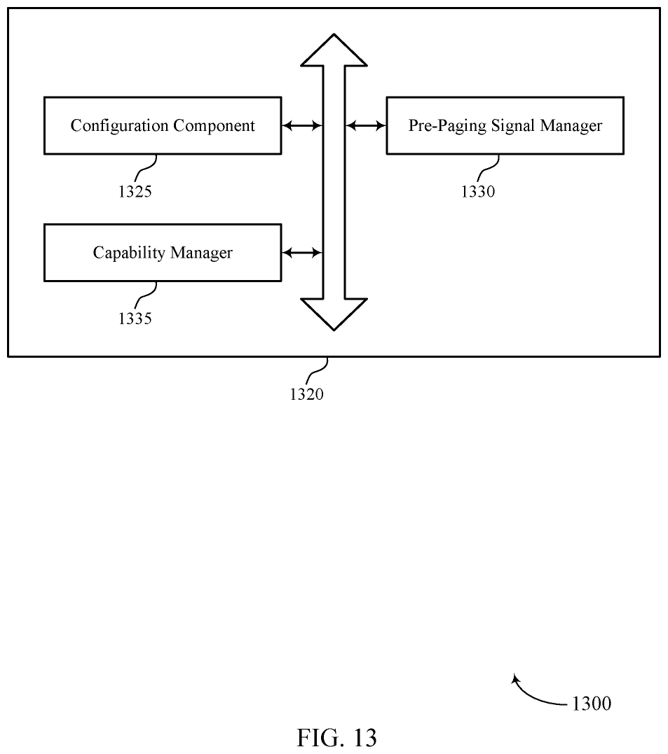

FIG. 13 shows a block diagram 1300 of a communications manager 1320 that supports pre-paging alert monitoring procedure in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of pre-paging alert monitoring procedure as described herein. For example, the communications manager 1320 may include a configuration component 1325, a pre-paging signal manager 1330, a capability manager 1335, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration component 1325 is capable of, configured to, or operable to support a means for transmitting, to a UE, an indication of a pre-paging signal configuration associated with monitoring by the UE for a pre-paging signal associated with a first cell, where the monitoring for the pre-paging signal is dependent on satisfaction of one or more conditions that are associated with the pre-paging signal configuration, and where the one or more conditions include failure of a criterion associated with selection of the first cell via a cell selection procedure by the UE. The pre-paging signal manager 1330 is capable of, configured to, or operable to support a means for transmitting, to the UE and via the first cell, the pre-paging signal in accordance with the pre-paging signal configuration, where the pre-paging signal indicates that the UE is to output an alert message.

In some examples, the configuration component 1325 is capable of, configured to, or operable to support a means for obtaining, from a network function, an indication of the pre-paging signal configuration.

In some examples, the failure of the criterion associated with selection of the first cell includes a reference signal received power (e.g., measured by the UE) failing to satisfy a first threshold value associated with monitoring for a paging message from the network entity.

In some examples, the one or more conditions being satisfied further includes the reference signal received power satisfying a second threshold value that is lower than the first threshold value. In some examples, the one or more conditions being satisfied includes the UE being within a system information block tracking area associated with the first cell. In some examples, the one or more conditions being satisfied includes the UE being within a geographical area indicated by the pre-paging signal configuration.

In some examples, the capability manager 1335 is capable of, configured to, or operable to support a means for receiving a capability message indicating a capability of the UE to operate in accordance with one or more pre-paging modes.

In some examples, the pre-paging signal configuration indicates a time offset between a pre-paging occasion for receiving the pre-paging signal and a corresponding paging occasion for receiving the paging message.

In some examples, to support transmitting the indication of the pre-paging signal configuration, the configuration component 1325 is capable of, configured to, or operable to support a means for transmitting a radio resource control message that indicates the pre-paging signal configuration.

In some examples, the pre-paging signal indicates a flag type of a set of multiple flag types. In some examples, the alert message is output based on the flag type.

In some examples, the set of multiple flag types includes at least one of a voice call flag type, a spam call flag type, a registration update flag type, delay tolerant uplink data flag type, important uplink data flag type, a connected mode flag type, or a flag type associated with the UE being in a cell selection state for a duration exceeding a threshold duration.

In some examples, each flag type of the set of multiple flag types corresponds to at least one alert type of a set of multiple alert types, the set of multiple alert types including a silent alert message, a vibration alert message, a ring alert message, and an omitted alert message. In some examples, the alert message corresponds to the indicated flag type.

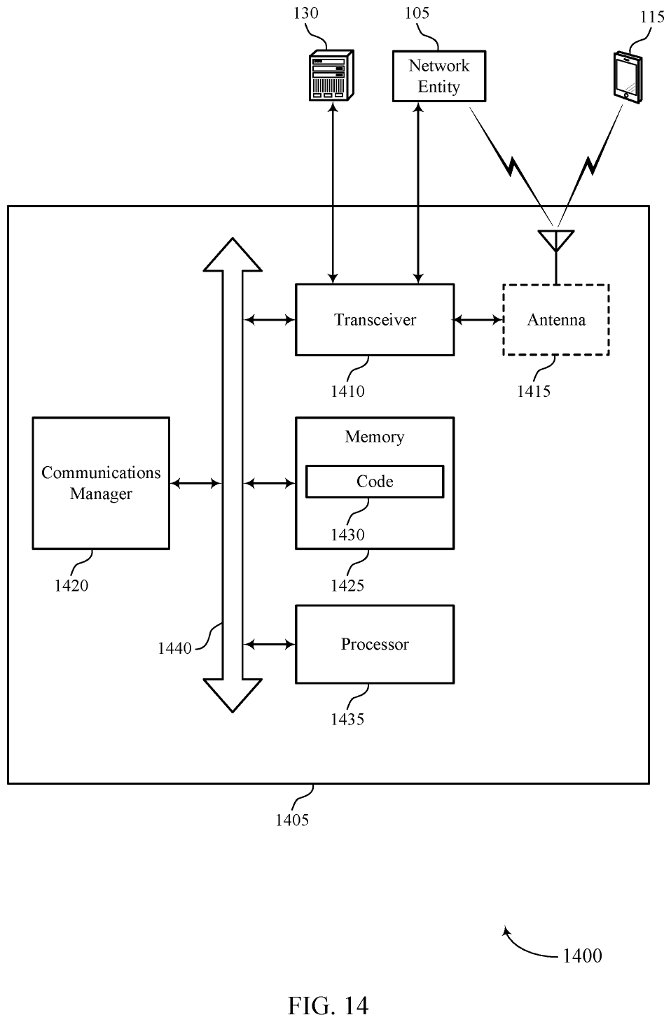

FIG. 14 shows a diagram of a system 1400 including a device 1405 that supports pre-paging alert monitoring procedure in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting pre-paging alert monitoring procedure). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. As such, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105 and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting, to a UE, an indication of a pre-paging signal configuration associated with monitoring by the UE for a pre-paging signal associated with a first cell, where the monitoring for the pre-paging signal is dependent on satisfaction of one or more conditions that are associated with the pre-paging signal configuration, and where the one or more conditions include failure of a criterion associated with selection of the first cell via a cell selection procedure (e.g., by the UE). The communications manager 1420 is capable of, configured to, or operable to support a means for transmitting, to the UE and via the first cell, the pre-paging signal in accordance with the pre-paging signal configuration, where the pre-paging signal indicates that the UE is to output an alert message.

By including or configuring the communications manager 1420 in accordance with examples as described herein, the device 1405 may support techniques for reception of pre-paging monitoring signals leading to improved utilization of communication resources due to improvements in coverage.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of pre-paging alert monitoring procedure as described herein, or the at least one processor 1435 and the at least one memory 1425 may be otherwise configured to, individually or collectively, perform or support such operations.

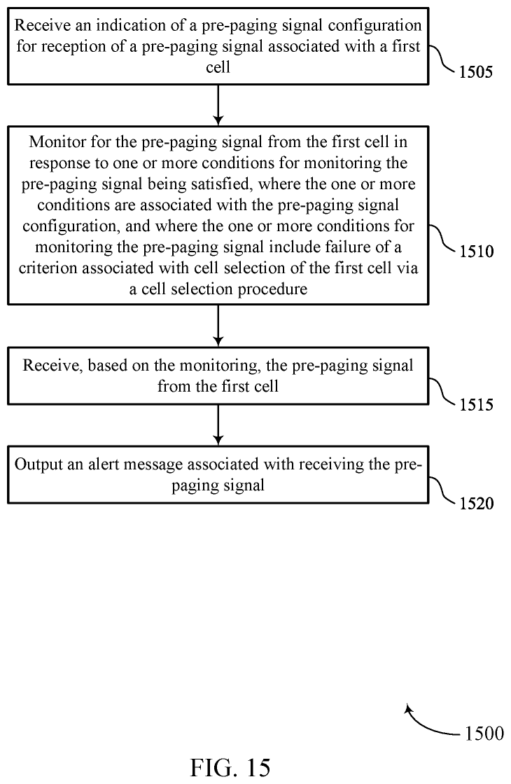

FIG. 15 shows a flowchart illustrating a method 1500 that supports pre-paging alert monitoring procedure in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a pre-paging signal configuration for reception of a pre-paging signal associated with a first cell. The operations of block 1505 may be performed in accordance with examples as disclosed herein. In some examples, aspects of the operations of 1505 may be performed by a configuration manager 925 as described with reference to FIG. 9.

At 1510, the method may include monitoring for the pre-paging signal from the first cell in response to one or more conditions being satisfied, where the one or more conditions for monitoring the pre-paging signal are associated with the pre-paging signal configuration, and where the one or more conditions for monitoring the pre-paging signal being satisfied includes failure of a criterion associated with selection of the first cell via a cell selection procedure. The operations of block 1510 may be performed in accordance with examples as disclosed herein. In some examples, aspects of the operations of 1510 may be performed by a condition component 930 as described with reference to FIG. 9.

At 1515, the method may include receiving, based on the monitoring, the pre-paging signal from the first cell. The operations of block 1515 may be performed in accordance with examples as disclosed herein. In some examples, aspects of the operations of 1515 may be performed by a pre-paging signal component 935 as described with reference to FIG. 9.

At 1520, the method may include outputting an alert message associated with receiving the pre-paging signal. The operations of block 1520 may be performed in accordance with examples as disclosed herein. In some examples, aspects of the operations of 1520 may be performed by an alert message component 940 as described with reference to FIG. 9.

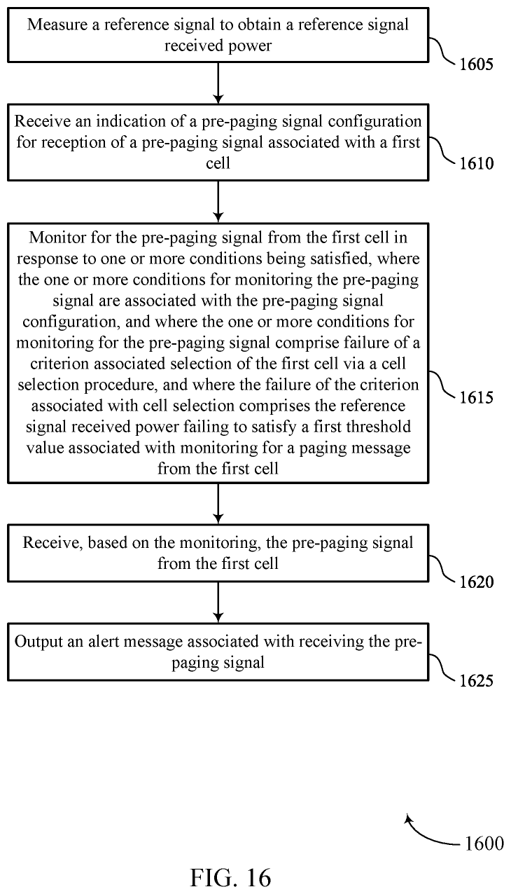

FIG. 16 shows a flowchart illustrating a method 1600 that supports pre-paging alert monitoring procedure in accordance with examples as described herein. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include measuring a reference signal to obtain a reference signal received power. The operations of block 1605 may be performed in accordance with examples as disclosed herein. In some examples, aspects of the operations of 1605 may be performed by a condition component 930 as described with reference to FIG. 9.

At 1610, the method may include receiving an indication of a pre-paging signal configuration for reception of a pre-paging signal associated with a first cell. The operations of block 1610 may be performed in accordance with examples as disclosed herein. In some examples, aspects of the operations of 1610 may be performed by a configuration manager 925 as described with reference to FIG. 9.

At 1615, the method may include monitoring for the pre-paging signal from the first cell in response to one or more conditions being satisfied, where the one or more conditions for monitoring the pre-paging signal are associated with the pre-paging signal configuration, where monitoring for the pre-paging signal is based on the reference signal received power failure of a criterion associated with cell reselection and with monitoring for a paging message, from the first cell, corresponding to the pre-paging signal, and where failing to satisfy the criterion associated with cell reselection is based at least in part on the reference signal received power failing to satisfy a first threshold value. The operations of block 1615 may be performed in accordance with examples as disclosed herein. In some examples, aspects of the operations of 1615 may be performed by a condition component 930 as described with reference to FIG. 9.

At 1620, the method may include receiving, based on the monitoring, the pre-paging signal from the first cell. The operations of block 1620 may be performed in accordance with examples as disclosed herein. In some examples, aspects of the operations of 1620 may be performed by a pre-paging signal component 935 as described with reference to FIG. 9.

At 1625, the method may include outputting an alert message associated with receiving the pre-paging signal. The operations of block 1625 may be performed in accordance with examples as disclosed herein. In some examples, aspects of the operations of 1625 may be performed by an alert message component 940 as described with reference to FIG. 9.

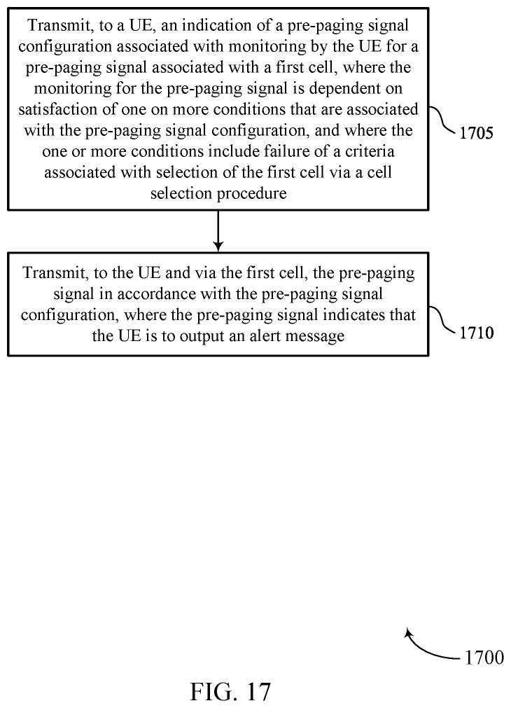

FIG. 17 shows a flowchart illustrating a method 1700 that supports pre-paging alert monitoring procedure in accordance with examples as described herein. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, an indication of a pre-paging signal configuration associated with monitoring by the UE for a pre-paging signal associated with a first cell, where the monitoring for the pre-paging signal is dependent on satisfaction of one or more conditions that are associated with the pre-paging signal configuration, and where the one or more conditions include failure of a criterion associated with selection of the first cell via a cell selection procedure. The operations of block 1705 may be performed in accordance with examples as disclosed herein. In some examples, aspects of the operations of 1705 may be performed by a configuration component 1325 as described with reference to FIG. 13.

At 1710, the method may include transmitting, to the UE and via the first cell, the pre-paging signal in accordance with the pre-paging signal configuration, where the pre-paging signal indicates that the UE is to output an alert message. The operations of block 1710 may be performed in accordance with examples as disclosed herein. In some examples, aspects of the operations of 1710 may be performed by a pre-paging signal manager 1330 as described with reference to FIG. 13.

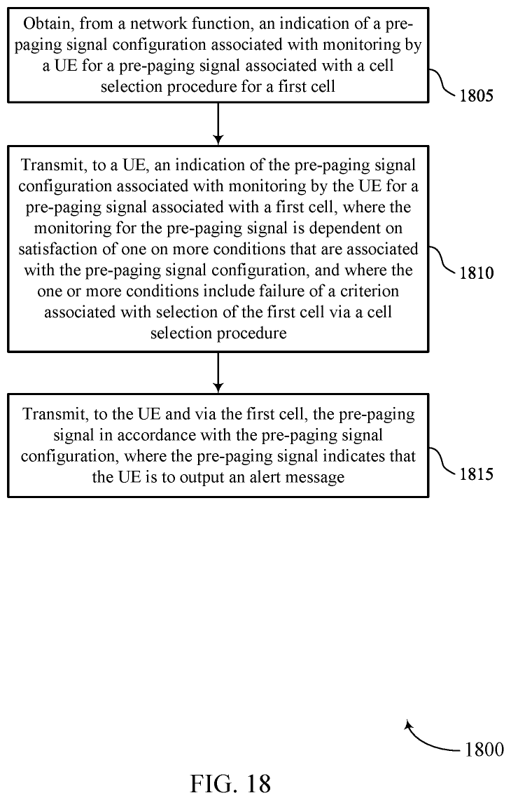

FIG. 18 shows a flowchart illustrating a method 1800 that supports pre-paging alert monitoring procedure in accordance with aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include obtaining, from a network function, an indication of the pre-paging signal configuration associated with monitoring by a UE for a pre-paging signal associated with a cell selection procedure for a first cell. The operations of block 1805 may be performed in accordance with examples as disclosed herein. In some examples, aspects of the operations of 1805 may be performed by a configuration component 1325 as described with reference to FIG. 13.

At 1810, the method may include transmitting, to the UE, an indication of a pre-paging signal configuration, where the pre-paging signal is associated with a corresponding paging message for the UE, where the monitoring for the pre-paging signal is dependent on satisfaction of one or more conditions that are associated with the pre-paging signal configuration, and where the one or more conditions include failure to satisfy a criterion associated with selection of the first cell. The operations of block 1810 may be performed in accordance with examples as disclosed herein. In some examples, aspects of the operations of 1810 may be performed by a configuration component 1325 as described with reference to FIG. 13.

At 1815, the method may include transmitting, to the UE and via the first cell, the pre-paging signal in accordance with the pre-paging signal configuration, where the pre-paging signal indicates that the UE is to output an alert message. The operations of block 1815 may be performed in accordance with examples as disclosed herein. In some examples, aspects of the operations of 1815 may be performed by a pre-paging signal manager 1330 as described with reference to FIG. 13.

The following provides an overview of aspects of the present disclosure:

Aspect 1: A method for wireless communications at a UE, comprising: receiving an indication of a pre-paging signal configuration for reception of a pre-paging signal associated with a first cell; monitoring for the pre-paging signal from the first cell in response to one or more conditions being satisfied, wherein the one or more conditions for monitoring the pre-paging signal are associated with the pre-paging signal configuration, and wherein the one or more conditions for monitoring the pre-paging signal comprise failure of a criterion associated with selection of the first cell via a cell selection procedure; receiving, based at least in part on the monitoring, the pre-paging signal from the first cell; and outputting an alert message associated with receiving the pre-paging signal.

Aspect 2: The method of aspect 1, further comprising: measuring a reference signal to obtain a reference signal received power, wherein the failure of the criterion associated with selection of the first cell comprises the reference signal received power failing to satisfy a first threshold value associated with monitoring for a paging message from the first cell.

Aspect 3: The method of aspect 2, wherein the one or more conditions being satisfied further comprises the reference signal received power satisfying a second threshold value that is lower than the first threshold value.

Aspect 4: The method of any of aspects 1 through 3, further comprising: storing data associated with one or more system information blocks for the first cell, wherein monitoring for the pre-paging signal is further based at least in part on storing the data associated with the one or more system information blocks.

Aspect 5: The method of aspect 4, wherein the one or more conditions being satisfied further comprises the UE being within a system information block tracking area associated with the one or more system information blocks.

Aspect 6: The method of any of aspects 1 through 5, further comprising: monitoring, in response to at least one condition of the one or more conditions being satisfied, for one or more system information blocks associated with the first cell; and performing a cell barring procedure to bar the first cell based at least in part on failing to detect the one or more system information blocks.

Aspect 7: The method of aspect 6, further comprising: performing, after performing the cell barring procedure to bar the first cell, a cell detection procedure for a second cell, wherein monitoring for the pre-paging signal from the first cell is based at least in part on failing to detect the second cell via the cell detection procedure.

Aspect 8: The method of aspect 7, wherein the one or more conditions being satisfied further comprises the UE being with a geographical area indicated by the pre-paging signal configuration.

Aspect 9: The method of any of aspects 1 through 8, further comprising: transmitting a capability message indicating a capability of the UE to operate in accordance with one or more pre-paging modes, wherein receiving the indication of the pre-paging signal configuration is associated with the indicated capability of the UE.

Aspect 10: The method of aspect 9, wherein the pre-paging signal configuration indicates at least one pre-paging mode in accordance with the capability of the UE, the pre-paging mode is associated with a set of one or more physical cell identifiers, a set of one or more frequency bandwidths, a set of one or more geographical areas, or any combination thereof associated with monitoring for the pre-paging signal, and monitoring for the pre-paging signal is based at least in part on the pre-paging mode.

Aspect 11: The method of any of aspects 1 through 10, wherein the one or more conditions being satisfied further comprises the UE operating without having received a synchronization signal block signal associated with the first cell, the UE operating having received the synchronization signal block signal, or the UE operating having received the synchronization signal block signal and paging downlink control information associated with the first cell.

Aspect 12: The method of any of aspects 1 through 11, wherein the one or more conditions being satisfied further comprises the UE operating without having obtained one or more valid system information blocks associated with the first cell or the UE operating having obtained one or more valid system information blocks associated with the first cell.

Aspect 13: The method of any of aspects 1 through 12, wherein the pre-paging signal configuration indicates a time offset between a pre-paging occasion for receiving the pre-paging signal and a corresponding paging occasion for receiving the paging message.

Aspect 14: The method of any of aspects 1 through 13, wherein receiving the indication of the pre-paging signal configuration comprises: receiving a radio resource control message that indicates the pre-paging signal configuration.

Aspect 15: The method of any of aspects 1 through 14, further comprising: initiating a random access procedure for communications with the first cell based at least in part on receiving the pre-paging signal.

Aspect 16: The method of any of aspects 1 through 15, wherein the pre-paging signal indicates a flag type of a plurality of flag types, and the alert message is output based at least in part on the flag type.

Aspect 17: The method of aspect 16, wherein the plurality of flag types comprises at least one of a voice call flag type, a spam call flag type, a registration update flag type, delay tolerant uplink data flag type, important uplink data flag type, a connected mode flag type, or a flag type associated with the UE being in a cell selection state for a duration exceeding a threshold duration.

Aspect 18: The method of any of aspects 16 through 17, wherein each flag type of the plurality of flag types corresponds to at least one alert type of a plurality of alert types, the plurality of alert types comprising a silent alert message, a vibration alert message, a ring alert message, and an omitted alert message, and the alert message corresponds to the indicated flag type.

Aspect 19: The method of any of aspects 1 through 18, further comprising: initiating a radio resource control reestablishment procedure based at least in part on triggering a radio link failure procedure while operating in a connected mode, wherein outputting the alert message is based at least in part on initiating the radio resource control reestablishment procedure.

Aspect 20: The method of aspect 19, wherein the alert message is output based at least in part on a quantity of radio resource control reestablishment procedure attempts exceeding a threshold quantity of attempts.

Aspect 21: The method of any of aspects 19 through 20, wherein the alert message is output based at least in part on the radio resource control reestablishment procedure being unsuccessful.

Aspect 22: The method of any of aspects 1 through 21, wherein the alert message indicates for the UE to be relocated to a different physical location.

Aspect 23: A method for wireless communications at a network entity, comprising: transmitting, to a UE, an indication of a pre-paging signal configuration associated with monitoring by the UE for a pre-paging signal associated with a first cell, wherein the monitoring for the pre-paging signal is dependent on satisfaction of one on more conditions that are associated with the pre-paging signal configuration, and wherein the one or more conditions being satisfied comprises failure of a criterion associated with selection of the first cell via a cell selection procedure; and transmitting, to the UE and via the first cell, the pre-paging signal in accordance with the pre-paging signal configuration, wherein the pre-paging signal indicates that the UE is to output an alert message.

Aspect 24: The method of aspect 23, further comprising: obtaining, from a network function, an indication of the pre-paging signal configuration.

Aspect 25: The method of any of aspects 23 through 24, wherein the failure of the criterion associated with selection of the first cell comprises a reference signal received power failing to satisfy a first threshold value associated with monitoring for a paging message from the network entity.

Aspect 26: The method of aspect 25, wherein the one or more conditions being satisfied further comprises the reference signal received power satisfying a second threshold value that is lower than the first threshold value.

Aspect 27: The method of any of aspects 23 through 26, wherein the one or more conditions being satisfied further comprises the UE being within a system information block tracking area associated with the first cell.

Aspect 28: The method of any of aspects 23 through 27, wherein the one or more conditions being satisfied further comprises the UE being within a geographical area indicated by the pre-paging signal configuration.

Aspect 29: The method of any of aspects 23 through 28, further comprising: receiving a capability message indicating a capability of the UE to operate in accordance with one or more pre-paging modes.

Aspect 30: The method of any of aspects 23 through 29, wherein the pre-paging signal configuration indicates a time offset between a pre-paging occasion for receiving the pre-paging signal and a corresponding paging occasion for receiving the paging message.

Aspect 31: The method of any of aspects 23 through 30, wherein transmitting the indication of the pre-paging signal configuration comprises: transmitting a radio resource control message that indicates the pre-paging signal configuration.

Aspect 32: The method of any of aspects 23 through 31, wherein the pre-paging signal indicates a flag type of a plurality of flag types, and the alert message is output based at least in part on the flag type.

Aspect 33: The method of aspect 32, wherein the plurality of flag types comprises at least one of a voice call flag type, a spam call flag type, a registration update flag type, delay tolerant uplink data flag type, important uplink data flag type, a connected mode flag type, or a flag type associated with the UE being in a cell selection state for a duration exceeding a threshold duration.

Aspect 34: The method of any of aspects 32 through 33, wherein each flag type of the plurality of flag types corresponds to at least one alert type of a plurality of alert types, the plurality of alert types comprising a silent alert message, a vibration alert message, a ring alert message, and an omitted alert message, and the alert message corresponds to the indicated flag type.

Aspect 35: A UE for wireless communications, comprising one or more memories storing processor-executable code, and one or more processors coupled with the one or more memories and individually or collectively operable to execute the code to cause the UE to perform a method of any of aspects 1 through 22.

Aspect 36: A UE for wireless communications, comprising at least one means for performing a method of any of aspects 1 through 22.

Aspect 37: A non-transitory computer-readable medium storing code for wireless communications, the code comprising instructions executable by a processor to perform a method of any of aspects 1 through 22.

Aspect 38: A network entity for wireless communications, comprising one or more memories storing processor-executable code, and one or more processors coupled with the one or more memories and individually or collectively operable to execute the code to cause the network entity to perform a method of any of aspects 23 through 34.

Aspect 39: A network entity for wireless communications, comprising at least one means for performing a method of any of aspects 23 through 34.

Aspect 40: A non-transitory computer-readable medium storing code for wireless communications, the code comprising instructions executable by a processor to perform a method of any of aspects 23 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, being “associated with” shall be construed as including being “based at least in part on” such that, for example, A being based at least in part on B is within the scope of A being associated with B.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of a pre-paging signal configuration for reception of a pre-paging signal associated with a first cell;
monitor the pre-paging signal from the first cell in response to one or more conditions being satisfied, where the one or more conditions for monitoring the pre-paging signal are associated with the pre-paging signal configuration, and wherein the one or more conditions for monitoring the pre-paging signal comprise failure of a criterion associated with selection of the first cell via a cell selection procedure;
receive, based at least in part on the monitoring, the pre-paging signal from the first cell; and
output an alert message associated with receiving the pre-paging signal.

2. The UE of claim 1, wherein the one or more processors are individually or collectively further operable to execute the code to cause the UE to:
measure a reference signal to obtain a reference signal received power, wherein the failure of the criterion associated with selection of the first cell comprises the reference signal received power failing to satisfy a first threshold value associated with monitoring for a paging message from the first cell.

3. The UE of claim 2, wherein the one or more conditions being satisfied further comprises the reference signal received power satisfying a second threshold value that is lower than the first threshold value.

4. The UE of claim 1, wherein the one or more processors are individually or collectively further operable to execute the code to cause the UE to:
store data associated with one or more system information blocks for the first cell, wherein monitoring for the pre-paging signal is further based at least in part on storing the data associated with the one or more system information blocks.

5. The UE of claim 4, wherein the one or more conditions being satisfied further comprises the UE being within a system information block tracking area associated with the one or more system information blocks.

6. The UE of claim 1, wherein the one or more processors are individually or collectively further operable to execute the code to cause the UE to:
monitor, in response to at least one condition of the one or more conditions being satisfied, for one or more system information blocks associated with the first cell; and
perform a cell barring procedure to bar the first cell based at least in part on failing to detect the one or more system information blocks.

7. The UE of claim 6, wherein the one or more processors are individually or collectively further operable to execute the code to cause the UE to:
perform, after performing the cell barring procedure to bar the first cell, a cell detection procedure for a second cell, wherein monitoring for the pre-paging signal from the first cell is based at least in part on failing to detect the second cell via the cell detection procedure.

8. The UE of claim 7, wherein the one or more conditions being satisfied further comprises the UE being with a geographical area indicated by the pre-paging signal configuration.

9. The UE of claim 1, wherein the one or more processors are individually or collectively further operable to execute the code to cause the UE to:
transmit a capability message indicating a capability of the UE to operate in accordance with one or more pre-paging modes, wherein receiving the indication of the pre-paging signal configuration is associated with the indicated capability of the UE.

10. The UE of claim 9, wherein the pre-paging signal configuration indicates at least one pre-paging mode in accordance with the capability of the UE, wherein the pre-paging mode is associated with a set of one or more physical cell identifiers, a set of one or more frequency bandwidths, a set of one or more geographical areas, or any combination thereof associated with monitoring for the pre-paging signal, and wherein monitoring for the pre-paging signal is based at least in part on the pre-paging mode.

11. The UE of claim 1, wherein the one or more conditions being satisfied further comprises the UE operating without having received a synchronization signal block signal associated with the first cell, the UE operating having received the synchronization signal block signal, or the UE operating having received the synchronization signal block signal and paging downlink control information associated with the first cell.

12. The UE of claim 1, wherein the one or more conditions being satisfied further comprises the UE operating without having obtained one or more valid system information blocks associated with the first cell or the UE operating having obtained one or more valid system information blocks associated with the first cell.

13. The UE of claim 1, wherein the pre-paging signal configuration indicates a time offset between a pre-paging occasion for receiving the pre-paging signal and a corresponding paging occasion for receiving a paging message, from the first cell, corresponding to the pre-paging signal.

14. The UE of claim 1, wherein the one or more processors are individually or collectively further operable to execute the code to cause the UE to:
initiate a random access procedure for communications with the first cell based at least in part on receiving the pre-paging signal.

15. The UE of claim 1, wherein the pre-paging signal indicates a flag type of a plurality of flag types, and wherein the alert message is output based at least in part on the flag type.

16. The UE of claim 15, wherein the plurality of flag types comprises at least one of a voice call flag type, a spam call flag type, a registration update flag type, delay tolerant uplink data flag type, important uplink data flag type, a connected mode flag type, or a flag type associated with the UE being in a cell selection state for a duration exceeding a threshold duration.

17. The UE of claim 15, wherein each flag type of the plurality of flag types corresponds to at least one alert type of a plurality of alert types, the plurality of alert types comprising a silent alert message, a vibration alert message, a ring alert message, and an omitted alert message, and wherein the alert message corresponds to the indicated flag type.

18. The UE of claim 1, wherein the one or more processors are individually or collectively further operable to execute the code to cause the UE to:
initiate a radio resource control reestablishment procedure based at least in part on triggering a radio link failure procedure while operating in a connected mode, wherein outputting the alert message is based at least in part on initiating the radio resource control reestablishment procedure.

19. The UE of claim 18, wherein the one or more processors are individually or collectively operable to execute the code to cause the UE to output the alert message based at least in part on a quantity of radio resource control reestablishment procedure attempts exceeding a threshold quantity of attempts.

20. The UE of claim 18, wherein the one or more processors are individually or collectively operable to execute the code to cause the UE to output the alert message based at least in part on the radio resource control reestablishment procedure being unsuccessful.

21. The UE of claim 1, wherein the alert message indicates for the UE to be relocated to a different physical location.

22. A network entity, comprising:
one or more memories storing processor-executable code; and
one or more processors coupled with the one or more memories and individually or collectively operable to execute the code to cause the network entity to:
transmit, to a user equipment (UE), an indication of a pre-paging signal configuration associated with monitoring by the UE for a pre-paging signal associated with a first cell, wherein the monitoring for the pre-paging signal is dependent on satisfaction of one or more conditions that are associated with the pre-paging signal configuration, and wherein the one or more conditions being satisfied comprises failure of a criterion associated with selection of the first cell via a cell selection procedure; and
transmit, to the UE and via the first cell, the pre-paging signal in accordance with the pre-paging signal configuration, wherein the pre-paging signal indicates that the UE is to output an alert message.

23. The network entity of claim 22, wherein the one or more processors are individually or collectively further operable to execute the code to cause the network entity to:
obtain, from a network function, an indication of the pre-paging signal configuration.

24. The network entity of claim 22, wherein the failure of the criterion associated with selection of the first cell comprises a reference signal received power failing to satisfy a first threshold value associated with monitoring for a paging message from the network entity.

25. The network entity of claim 24, wherein the one or more conditions being satisfied further comprises the reference signal received power satisfying a second threshold value that is lower than the first threshold value.

26. The network entity of claim 22, wherein the one or more conditions being satisfied further comprises the UE being within a system information block tracking area associated with the first cell.

27. The network entity of claim 22, wherein the one or more conditions being satisfied further comprises the UE being within a geographical area indicated by the pre-paging signal configuration.

28. The network entity of claim 22, wherein the one or more processors are individually or collectively further operable to execute the code to cause the network entity to:
receive a capability message indicating a capability of the UE to operate in accordance with one or more pre-paging modes.

29. A method for wireless communications at a user equipment (UE), comprising:
receiving an indication of a pre-paging signal configuration for reception of a pre-paging signal associated with a first cell;
monitoring for the pre-paging signal from the first cell in response to one or more conditions being satisfied, where the one or more conditions for monitoring the pre-paging signal are associated with the pre-paging signal configuration, and wherein the one or more conditions for monitoring the pre-paging signal being satisfied comprises failure of a criterion associated with selection of the first cell via a cell selection procedure;
receiving, based at least in part on the monitoring, the pre-paging signal from the first cell; and
outputting an alert message associated with receiving the pre-paging signal.

30. A method for wireless communications at a network entity, comprising:
transmitting, to a user equipment (UE), an indication of a pre-paging signal configuration associated with monitoring by the UE for a pre-paging signal associated with a first cell, wherein the monitoring for the pre-paging signal is dependent on satisfaction of one or more conditions that are associated with the pre-paging signal configuration, and wherein the one or more conditions being satisfied comprises failure of a criterion associated with selection of the first cell via a cell selection procedure; and
transmitting, to the UE and via the first cell, the pre-paging signal in accordance with the pre-paging signal configuration, wherein the pre-paging signal indicates that the UE is to output an alert message.
